(19) United States
(12) Patent Application Publication
(10) Pub. No.: US 2025/0260968 A1
(43) Pub. Date: Aug. 14, 2025

(54) SYSTEMS, METHODS, AND APPARATUSES FOR IMPROVED CONNECTIVITY DISTRIBUTION

(71) Applicant: KORE Wireless Inc., Atlanta, GA (US)

(72) Inventors: James Dabbs, Atlanta, GA (US); Craig Fanti, Atlanta, GA (US); Kevin Jones, Atlanta, GA (US); Tushar Sachdev, Atlanta, GA (US); Eric Shorb, Atlanta, GA (US)

(21) Appl. No.: 19/054,494

(22) Filed: Feb. 14, 2025

Related U.S. Application Data
(63) Continuation of application No. PCT/US2025/016058, filed on Feb. 14, 2025.
(60) Provisional application No. 63/553,402, filed on Feb. 14, 2024.

(51) Int. Cl. H04W 8/18; H04L 43/0805

(52) U.S. Cl. CPC H04W 8/18; H04L 43/0805

(57) ABSTRACT

Systems, processes, and apparatuses are disclosed including an orchestration agent and an orchestration hub. The orchestration agent is operatively connected to an eUICC and memory at a mobile computing device. The orchestration hub includes a processor and a database including centralized network subscription information. The orchestration hub can receive updated network subscription information from a device management and from a network connectivity management platform. The orchestration hub can compare the updated network subscription information to a plurality of subscription records in the centralized network subscription information. The orchestration hub generates a new subscription record including current network subscription information based on the updated network subscription information. The orchestration agent can replace one or more information fields of a subscription edge record at the eUICC and the memory with corresponding information fields from the new subscription record.

### CROSS REFERENCE TO RELATED APPLICATIONS

This application is a Continuation Patent Application of, and claims the benefit of and priority to, International Patent Application No. PCT/US25/16058, filed on Feb. 14, 2025, and entitled “SYSTEMS, METHODS, AND APPARATUSES FOR IMPROVED CONNECTIVITY DISTRIBUTION,” which claims the benefit of and priority to U.S. Provisional Patent Application No. 63/553,402, filed on Feb. 14, 2024, and entitled “SYSTEMS, METHODS, AND APPARATUSES FOR IMPROVED CONNECTIVITY DISTRIBUTION,” the disclosures of which are incorporated by reference in their entireties as if the same were fully set forth herein.

### TECHNICAL FIELD

The present systems, processes, and apparatuses relate generally to digital telecommunications and, more particularly to systems, methods, and apparatuses for improved connectivity distribution.

### BACKGROUND

Remote SIM Provisioning (RSP) relates to a process for downloading and managing eSIM profiles on mobile devices for connecting to cellular networks. RSP for consumer devices (such as cell phones) has improved over the years due to advancements from organizations such as the Global System for Mobile Communications Associate (GSMA) via standards and specifications including SGP.02, SGP.22, and SGP.32. However, when applied to internet of things (IoT) devices, particularly unattended devices, RSP encounters numerous challenges. But for those numerous challenges, RSP could provide material benefits to IoT system management; however, none of SGP.02, SGP.22, and SGP.32 can provide each of the following capabilities for overcoming the shortcomings of using RSP for IoT system management: synchronizing RSP operations with device operations and availability; including subscription context information with downloaded eSIM profiles; providing access to RSP servers when internet is not available; enabling downloads through non-cellular connectivity; and enabling local profile management. Therefore, there is a long-felt but unmet need for systems, methods, and apparatuses for improved connectivity distribution via deploying mobile network subscriber identities to IoT devices.

### BRIEF SUMMARY

Briefly described, and according to one embodiment, aspects of the present disclosure generally relate to systems, methods, and apparatuses for improved cellular device connectivity distribution.

In particular, aspects of the present disclosure relate to remote SIM provisioning (RSP) in internet of things (IoT) environments. For example, consider a scenario in which hundreds, thousands, hundreds of thousands, etc., of cellular IoT devices require information relating to accessing one or more cellular networks for receiving and transmitting data. According to various aspects of the present disclosure, the system described herein includes an orchestration hub for transmitting, from a centralized location and synchronized according to device availability, cellular network subscription information to IoT devices. In at least one example, orchestration hub can be operatively connected to one or more device management systems (device managers). The orchestration hub can also be operatively connected to one or more connectivity management systems (connectivity managers). According to various aspects of the present disclosure, the orchestration hub can install, configure, update, and delete subscriptions (including subscriber identity and subscription context) on remote IoT devices. Aspects of the present disclosure further support profile content management and eSIM profiles with multiple IMSIs.

In at least one example, the orchestration hub can be operatively configured to receive subscription source rows from one or more device managers, connectivity managers, and other management platforms. The orchestration hub can determine whether the subscription source rows include updated subscription configuration information, and the orchestration hub can merge updated subscription configuration information into a record of stored subscription information within the orchestration hub. Merging updated subscription configuration information into a record of stored subscription information within the orchestration hub can include generating a new subscription information record entry (a subscription information “row”), replacing or overwriting existing subscription information stored within the orchestration hub, etc. In certain examples, the orchestration hub can generate and transmit remote SIM provisioning (RSP) application protocol data unit (APDU) messages to IoT devices in response to the devices becoming available (e.g., waking from an idle state, finishing a separate processing task, connecting to the network, etc.). The RSP APDUs can include the updated subscription configuration information which can replace preexisting subscription information at the IoT devices.

Further, the present disclosure allows for device operations (e.g., queries transmitted to devices to initiate particular actions) to be organized as campaigns. In one example, a campaign can be a set of sequentially ordered operations applied to one or more devices. While operations can be sequential and ordered for each device in a campaign, devices themselves can be handled in parallel. For example, a campaign can include two installation operations, followed by a delete operation, each performed on a plurality of devices. For example, for a campaign applied to 500 devices, the orchestration hub can simultaneously initiate 500 install operations. In at least one example, as the install operations complete, the orchestration hub can begin follow-on operations on a device-by-device basis. Campaigns can offer an advantageous management structure in cases where RSP operations may incur cost, which can be controlled and accounted for differently than other aspects of device management.

According to a first aspect, or any other aspect, the present disclosure discusses a system including: an orchestration agent including a software configuration installed at a mobile computing device, wherein the orchestration agent is operatively connected to an embedded universal integrated circuit card (eUICC) and memory at the mobile computing device; and an orchestration hub operatively connected to the orchestration agent, wherein the orchestration hub includes a processor and a database including centralized network subscription information sourced from one or more management platforms, wherein the processor is operatively configured to: receive first updated network subscription information from a device management platform of the one or more management platforms; receive second updated network subscription information from a network connectivity management platform of the one or more management platforms; compare the first updated network subscription information and the second updated network subscription information to a plurality of subscription records in the centralized network subscription information; in response to determining a common identifier between a particular subscription record of the plurality of subscription records, the first updated network subscription information, and the second updated network subscription information, generate a new subscription record including current network subscription information based on the first updated network subscription information and the second updated network subscription information; and transmit a replicated version of the new subscription record to the orchestration agent at the mobile computing device, wherein the orchestration agent is operatively configured to replace one or more information fields of a subscription edge record at the eUICC and the memory with corresponding information fields from the replicated version of the new subscription record.

According to a second aspect, or any other aspect, the common identifier is an Integrated Circuit Card Identification (ICCID) value.

According to a third aspect, or any other aspect, transmitting the replicated version of the new subscription record to the orchestration agent includes transmitting the replicated version of the new subscription record to the orchestration agent through a network tunnel.

According to a fourth aspect, or any other aspect, the orchestration hub is operatively configured to transmit the replicated version of the new subscription record in response to receiving an indication of device availability.

According to a fifth aspect, or any other aspect, the orchestration hub is operatively connected to a subscription manager data preparation plus (SM-DP+) server.

According to a sixth aspect, or any other aspect, the subscription edge record includes an eSIM profile, received from the SM-DP+ server, stored within the eUICC, and the subscription edge record further includes subscription context information, received from the network connectivity management platform, stored within the memory.

According to a seventh aspect, or any other aspect, the orchestration hub is operatively configured to update the eSIM profile via one or more APDU scripts.

According to an eighth aspect, or any other aspect, the present disclosure describes a method including: receiving first updated network subscription information from a device management platform of one or more management platforms; receiving second updated network subscription information from a network connectivity management platform of the one or more management platforms; comparing the first updated network subscription information and the second updated network subscription information to a plurality of subscription records in centralized network subscription information stored in an orchestration hub; in response to determining a common identifier between a particular subscription record of the plurality of subscription records, the first updated network subscription information, and the second updated network subscription information, generating a new subscription record including current network subscription information based on the first updated network subscription information and the second updated network subscription information; and transmitting a replicated version of the new subscription record to an orchestration agent at a mobile computing device, wherein the orchestration agent is operatively configured to replace one or more information fields of a subscription edge record at an eUICC and a memory at the mobile computing device with corresponding information fields from the replicated version of the new subscription record.

According to a nineth aspect, or any other aspect, the common identifier is an Integrated Circuit Card Identification (ICCID) value.

According to a tenth aspect, or any other aspect, transmitting the replicated version of the new subscription record to the orchestration agent includes transmitting the replicated version of the new subscription record to the orchestration agent through a network tunnel.

According to an eleventh aspect, or any other aspect, the orchestration hub is operatively configured to transmit the replicated version of the new subscription record in response to receiving an indication of device availability.

According to a twelfth aspect, or any other aspect, the orchestration hub is operatively connected to a subscription manager data preparation plus (SM-DP+) server.

According to a thirteenth aspect, or any other aspect, the subscription edge record includes an eSIM profile, received from the SM-DP+ server, stored within the eUICC, and the subscription edge record further includes subscription context information, received from the network connectivity management platform, stored within the memory.

According to a fourteenth aspect, or any other aspect, the orchestration hub is operatively configured to update the eSIM profile via one or more APDU scripts.

According to a fifteenth aspect, the present disclosure describes a non-transitory computer readable medium including instructions, that when read by a processor, cause the processor to perform: receiving first updated network subscription information from a device management platform of one or more management platforms; receiving second updated network subscription information from a network connectivity management platform of the one or more management platforms; comparing the first updated network subscription information and the second updated network subscription information to a plurality of subscription records in centralized network subscription information stored in an orchestration hub; in response to determining a common identifier between a particular subscription record of the plurality of subscription records, the first updated network subscription information, and the second updated network subscription information, generating a new subscription record including current network subscription information based on the first updated network subscription information and the second updated network subscription information; and transmitting a replicated version of the new subscription record to an orchestration agent at a mobile computing device, wherein the orchestration agent is operatively configured to replace one or more information fields of a subscription edge record at an eUICC and a memory at the mobile computing device with corresponding information fields from the replicated version of the new subscription record.

According to a sixteenth aspect, or any other aspect, the common identifier is an Integrated Circuit Card Identification (ICCID) value.

According to a seventeenth aspect, or any other aspect, transmitting the replicated version of the new subscription record to the orchestration agent includes transmitting the replicated version of the new subscription record to the orchestration agent through a network tunnel.

According to an eighteenth aspect, or any other aspect, the non-transitory computer readable medium discussed herein and further including instructions that, when read by the processor, cause the orchestration hub to transmit the replicated version of the new subscription record in response to receiving an indication of device availability.

According to a nineteenth aspect, or any other aspect, the orchestration hub is operatively connected to a subscription manager data preparation plus (SM-DP+) server.

According to a twentieth aspect, or any other aspect, the subscription edge record includes an eSIM profile received from the SM-DP+ server and stored within the eUICC, and the subscription edge record further includes subscription context information received from the network connectivity management platform and stored within the memory, and wherein the wherein the orchestration hub is operatively configured to update the eSIM profile via one or more APDU scripts.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of an example system environment, in accordance with the disclosed technology;

FIG. 2 is a diagram of an example device of the plurality of devices, in accordance with the disclosed technology;

FIG. 3 is a diagram of an example interface environment of the orchestration agent, in accordance with the disclosed technology;

FIG. 4 is a diagram illustrating a subscription edge record, in accordance with the disclosed technology;

FIG. 5 is a diagram illustrating a subscription row replication process, in accordance with the disclosed technology;

FIG. 6 is a flowchart of an example subscription source row update process, in accordance with the disclosed technology;

FIG. 7 is a flowchart of an example edge row update process, in accordance with the disclosed technology;

FIG. 8 is a flowchart of an example edge row update process, in accordance with the disclosed technology;

FIG. 9 is a state diagram of an example subscription edge record, in accordance with the disclosed technology;

FIG. 10 is a diagram illustrating an example subscription installation, in accordance with the disclosed technology;

FIG. 11 is a diagram illustrating an example subscription installation, in accordance with the disclosed technology;

FIG. 12 is a diagram illustrating an example subscription installation, in accordance with the disclosed technology;

FIG. 13 is a sequence diagram illustrating an example agent-hub interface process, in accordance with the disclosed technology;

FIG. 14 is a diagram of an example data structure, in accordance with the disclosed technology;

FIG. 15 is a sequence diagram showing a first AHI forward operation call with an initially unavailable device, in accordance with the disclosed technology;

FIG. 16 is a sequence diagram showing a second AHI forward operation call with an initially available device, in accordance with the disclosed technology;

FIG. 17 is a sequence diagram showing an AHI reverse operation call, in accordance with the disclosed technology;

FIG. 18 is a sequence diagram showing a first install operation, in accordance with the disclosed technology;

FIG. 19 is a sequence diagram showing a second install operation using a profile installation script, in accordance with the disclosed technology;

FIG. 20 is a sequence diagram showing a first update operation without profile content management, in accordance with the disclosed technology;

FIG. 21 is a sequence diagram showing a second update operation with profile content management, in accordance with the disclosed technology;

FIG. 22 is a sequence diagram showing a delete operation, in accordance with the disclosed technology;

FIG. 23A-23C are sequence diagrams for querying, reading, and updating device subscription information, in accordance with the disclosed technology;

FIG. 24 is a lifecycle state machine for a campaign, in accordance with the disclosed technology;

FIG. 25 is a sequence diagram for a campaign of install operations, in accordance with the disclosed technology;

FIG. 26 is a sequence diagram for a campaign of update operations, in accordance with the disclosed technology; and

FIG. 27 is a sequence diagram for a campaign of delete operations, in accordance with the disclosed technology.

### DETAILED DESCRIPTION

The disclosed technology generally relates to systems, methods, and apparatuses for improved cellular device connectivity distribution. Some examples of the disclosed technology will be described more fully with reference to the accompanying drawings. However, this disclosed technology may be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed electronic devices and methods. Such other components not described herein may include, but are not limited to, for example, components developed after development of the disclosed technology.

Throughout this disclosure, various aspects of the disclosed technology can be presented in a range of formats (e.g., a range of values). It should be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, the ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicates that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims. All limitations of scope should be determined in accordance with and as expressed in the claims.

### Overview

Briefly described, and according to one embodiment, aspects of the present disclosure generally relate to systems, methods, and apparatuses for improved cellular device connectivity distribution.

In particular, aspects of the present disclosure relate to remote SIM provisioning (RSP) in internet of things (IoT) environments. For example, consider a scenario in which hundreds, thousands, hundreds of thousands, etc., of cellular IoT devices require information relating to accessing one or more cellular networks for receiving and transmitting data. According to various aspects of the present disclosure, the system described herein includes an orchestration hub for transmitting, from a centralized location and synchronized according to device availability, cellular network subscription information to IoT devices. In at least one example, orchestration hub can be operatively connected to one or more device management systems (device managers). The orchestration hub can also be operatively connected to one or more connectivity management systems (connectivity managers). According to various aspects of the present disclosure, the orchestration hub can install, configure, update, and delete subscriptions (including subscriber identity and subscription context) on remote IoT devices. Aspects of the present disclosure further support profile content management and eSIM profiles with multiple IMSIs.

In at least one example, the orchestration hub can be operatively configured to receive subscription source rows from one or more device managers, connectivity managers, and other management platforms. The orchestration hub can determine whether the subscription source rows include updated subscription configuration information, and the orchestration hub can merge updated subscription configuration information into a record of stored subscription information within the orchestration hub. Merging updated subscription configuration information into a record of stored subscription information within the orchestration hub can include generating a new subscription information record entry (a subscription information “row”), replacing or overwriting existing subscription information stored within the orchestration hub, etc. In certain examples, the orchestration hub can generate and transmit remote SIM provisioning (RSP) application protocol data unit (APDU) messages to IoT devices in response to the devices becoming available (e.g., waking from an idle state, finishing a separate processing task, connecting to the network, etc.). The RSP APDUs can include the updated subscription configuration information which can replace preexisting subscription information at the IoT devices.

Further, the present disclosure allows for device operations (e.g., queries transmitted to devices to initiate particular actions) to be organized as campaigns. In one example, a campaign can be a set of sequentially ordered operations applied to one or more devices. While operations can be sequential and ordered for each device in a campaign, devices themselves can be handled in parallel. For example, a campaign can include two installation operations, followed by a delete operation, each performed on a plurality of devices. For example, for a campaign applied to 500 devices, the orchestration hub can simultaneously initiate 500 install operations. In at least one example, as the install operations complete, the orchestration hub can begin follow-on operations on a device-by-device basis. Campaigns can offer an advantageous management structure in cases where RSP operations may incur cost, which can be controlled and accounted for differently than other aspects of device management.

### Example Embodiments

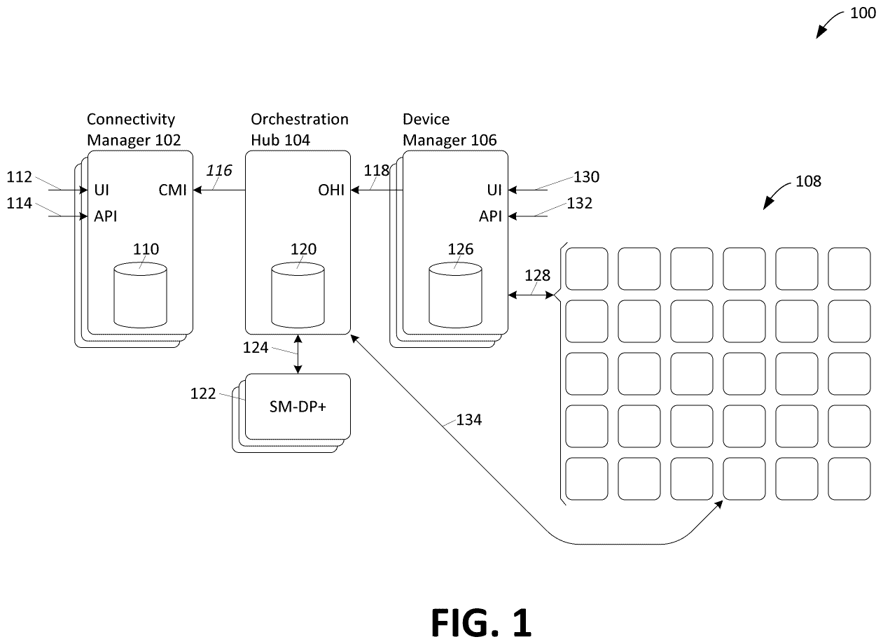

Referring now to the figures, for the purposes of example and explanation of the fundamental processes and components of the disclosed systems, methods, and apparatuses, reference is made to FIG. 1, which illustrates an example system environment 100. As will be understood and appreciated, the example system environment 100 shown in FIG. 1 represents merely one approach or embodiment of the present system, and other aspects are used according to various embodiments of the present system.

As shown in FIG. 1, the example system environment 100 can include one or more connectivity managers 102, one or more orchestration hubs 104, and one or more device managers 106. According to various aspects of the present disclosure, the orchestration hub 104 can be operatively connected to one or more devices of a plurality of devices 108. In one example, the device manager 106 can be operatively connected to one or more devices of the plurality of devices 108.

In at least one example, the connectivity manager 102 can be a software and hardware service platform. The connectivity manager 102 can be operatively configured to enable users to obtain and manage subscriptions, such as connectivity subscriptions to wireless networks. In one example, subscriptions can allow devices to transmit and receive data (typically under a defined agreement). Subscriptions, and subscription information or subscription context, can include data such as a subscriber identity, in the form of an International Mobile Subscriber Identity (IMSI), or IMSI's, and a secret key value shared between a Subscriber Identity Module (“SIM” or “eSIM Profile”) and a network (home subscriber server (HSS), AuC, 5GC, etc.). In certain examples, subscriptions can also include other configuration information stored in one or more partner networks, information corresponding to agreements between networks, etc.

The connectivity manager 102 can be operated by mobile network operators, mobile virtual network operators, connectivity resellers, private system operators, satellite system operators, and other enterprises. However, in one example, the connectivity manager 102 can be operated and/or controlled internally (via an administrator of the system 100). The connectivity manager 102 can include a subscription database 110. In one example, the subscription database 110 can include data ranging from an HSS or 5GC (as might be implemented by a mobile network operator), to one or more subscription tables (as might be implemented for resale platforms).

The connectivity manager 102 can include a user interface (UI) 112 and an application programming interface (API) 114. In one example, the UI 112 and the API 114 can be operatively configured to allow for users and software clients to obtain and manage subscriptions. In at least one example, the connectivity manager 102 can also include a connectivity manager interface (CMI) 116. According to various aspects of the present disclosure, the CMI 116 can be operatively configured to provide one or more services to the orchestration hub 104. In various embodiments, the CMI 116 can be implemented using a remote procedure call (RPC) framework, such as gRPC. In this example, the connectivity manager 102 can be the server, and the orchestration hub 104 can be the client. In certain examples, additional client-to-server notification channels can be implemented with the server streaming capabilities of gRPC. In other examples, CMI 116 can be implemented by using REST, GraphQL, WebSockets, an event/stream infrastructure such as Apache Kafka, or other similar means.

In one example, the orchestration hub 104 can be a software and hardware service platform operatively configured to provide advanced services corresponding to remote SIM provisioning (RSP) and eSIM orchestration. The orchestration hub 104 includes an orchestration hub interface (OHI) 118, which can provide defined services to the one or more device managers 106. In the illustrative embodiment, OHI 118 can be implemented using gRPC, with the orchestration hub 104 as server, and device manager(s) 106 as the client, with an additional client-to-server notification channel implemented with the server streaming capabilities of gRPC. In other embodiments, OHI 118 can be implemented by using REST, GraphQL, WebSockets, an event/stream infrastructure such as Apache Kafka, or other similar means.

The orchestration hub 104 can be operatively configured to interface with the CMI 116 and other connectivity manager 102 services. In one example, and for connectivity managers 102 that do not support CMI 116, a proxy or adapter service may be constructed to convert a connectivity manager's native API 132 into equivalent CMI 116 services, or a subset thereof, depending on the capabilities of the connectivity manager 102. The orchestration hub 104 can include a database 120 to store information such as subscription information related to connectivity managers 102, device information related to device managers 106, etc.

In one example, the orchestration hub 104 can be operatively connected to one or more Subscription Manager-Data Preparation Plus (SM-DP+) servers 122. Accordingly, the orchestration hub 104 can be configured to perform ES9+ operations 124 with SM-DP+ servers 122, as needed, to assist devices 108 with downloads (eSIM profile downloads) and notification reports (eSIM profile update notifications). A person of ordinary skill in the art would understand that the orchestration hub 104 could also support ES11 connections to SM-DS servers, to allow the example embodiment to make use of GSMA Discovery Service and other similar services.

In one example, the device manager 106 can be a management platform. In particular, the device manager can be a software platform operatively configured to provide the ability to configure, operate, and manage the devices 108. Example device managers 106 include systems to manage payment terminals, asset trackers, cellular routers, LTE gateways, utility meters, fleet management devices, sensors, PLCs, and other types of mobile and fixed connected hardware nodes. A device manager 106 can include a device management database 126. The device management database 126 can include a table of device-related rows and other supporting tables and data structures. The device manager 106 can implement one or more device management protocols 128. The device management protocols 128 can allow for the device manager 106 to communicate with and manage devices 108. Device management protocols 128 can be implemented using standards such as MQTT or LwM2M. In at least one example, the device management protocols 128 can be built on top of lower-level IP standards such as TLS, TCP, UDP, CoAP, DTLS. In certain examples, the device management protocols 128 can be built on top of other physical layers such as mesh, multiple-address systems, point-to-multipoint systems, serial links, or other schemes entirely. The device manager 106 can include a UI 130 and an API 132. The UI 130 and the API 132 can enable users and software clients to manage the devices 108. The device manager 106 can also include client software for the orchestration hub interface (OHI) service 118, which access the services of the orchestration hub 104.

As will be described in more detail below, an agent hub interface (AHI) 134 can be configured to tunnel through other system interfaces and protocols. In one example, the AHI 134 can enable bidirectional communications between the orchestration hub 104 and the devices 108.

For purposes of illustration and for ease of understanding, the connectivity manager 102, the orchestration hub 104, and the device managers 106 are shown as monolithic elements in the example system environment 100. It should be understood from the discussion herein that the connectivity manager 102, the orchestration hub 104, and the device manager 106 can be implemented as distributed systems or as subcomponents of larger distributed systems. In one example, the connectivity manager 102, the orchestration hub 104, and the device manager 106 can be configured to include overlapping aspects (such as a combined connectivity manager 102 and orchestration hub 104, a combined orchestration hub 104 and device manager 106, or other combinations). Despite the example system environment 100 showing a single orchestration hub 104, the system disclosed herein can support multiple orchestration hubs 104, as well as multi-tenant orchestration hubs 104, connectivity managers 102, and device managers 106 interconnected in a plurality of arrangements (for example, many-to-many type arrangements).

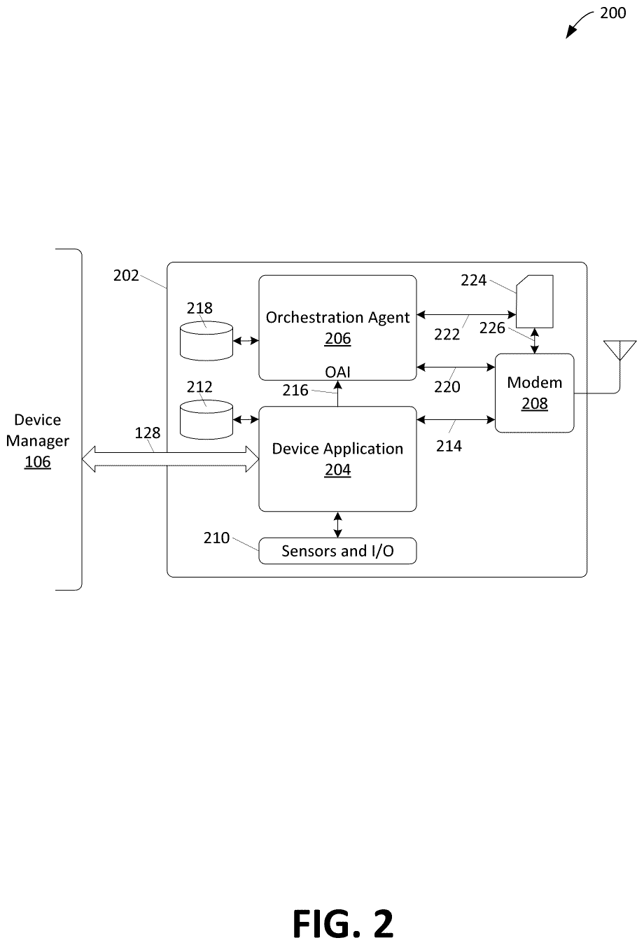

FIG. 2 is an architecture diagram 200 of an example device 202 of the plurality of devices 108. In one example, the device 202 can be a processing node. The device 202 can include both hardware and software components. The device 202 can include computing resources such as a central processing unit (CPU) and/or a microcontroller, as well as memory, a power source, I/O, and other computing resources. In one example, the device 202 can be of various types, such as routers, gateways, in-vehicle tracking units, utility meters, and other device types.

In one example, the device 202 can include components such as a device application 204, an orchestration agent 206, a modem 208, sensors and data input/output (I/O) 210, and other components. The device application 204 can be a software application. In at least one example, the device application 204 can include software written in the C and C++ languages. The device application 204 can include both an embedded operating system (OS) and application code. The device 202 can be implemented with a distinct OS, and it can host multiple device applications 204 developed in various computer languages and frameworks.

The device application 204 can be operatively connected to the sensors and I/O 210. The device application 204 can control the sensors and I/O 210. In one example, the sensors and I/O 210 can include various sensors and I/O ports and interfaces such as temperature sensors, Ethernet ports, RS-485 ports, MDB interfaces, PID loops, analog ports, GPIO, etc.

The device application 204 can be operatively connected to a nonvolatile local database (or data storage) 212. The database 212 can store information such as configuration, operating state, queued sensor measurements, and other data. The device application 204 can connect to the modem 208 using an interface 214 such as TS 127 007, PPP, QMI, MBIM, Android RIL, or other interfaces.

While the example device 202 shows a single modem 208, it should be understood from the discussion herein that the device 202 can include one or more modems 208. In one example, the modem 208 can be a cellular modem. The modem 208 and/or the sensors and I/O 210 can allow for the device application 204 to communicate with the device manager 106. In one example, the device application 204 communicates with the device manager 106 via the device management protocol 128.

In one example, the orchestration agent 206 can be operatively configured to interface with the device application 204 using an orchestration agent interface (OAI) 216. In the illustrative embodiment, the orchestration agent 206 can be implemented as a C library of procedures (methods) that directly link into the device application 204. In other embodiments, the orchestration agent 206 can be implemented as a separate task, process, or hardware module, interfacing with the device application 204 (or applications 204) as using shared memory, pipes, or other inter-process communication mechanisms. In one example, the orchestration agent 206 can be implemented as a kernel module, interfacing with the device application 204 using IOCTL, read, write, or other driver calls.

The orchestration agent 206 can serve several functions within the illustrative embodiment, including a role similar to that of a local agent as described in the Global Platform SE RAM protocol, a role similar to that of a local profile assistant as described in the SGP.22 specification, and a role as a local subscription server. The orchestration agent 206 can be operatively connected to a local store 218. The orchestration agent 206 can use the local store 218 for storing and retrieving configuration and state data. The orchestration agent local store 218 can be within the same physical device as the device application database 212. For example, the orchestration agent local store 218 and the device application database 212 can be arbitrated by a file system or other means. In one example, the orchestration agent local store 218 and the device application database 212 can be separate physical hardware.

The orchestration agent 206 can include a modem interface 220. The modem interface 220 can be connected (logically and/or physically) to the modem 208. The modem interface 220 can be the same physical interface as the device application interface 214, arbitrated between the device application 204 and orchestration agent 206, or it may be an independent physical interface. The orchestration agent 206 can also include an interface 222 to an eUICC 224.

In one example, the eUICC 224 can be software running on secure hardware such as an ISO/IEC 7816 compliant smart card, trusted execution environment, secure enclave, secure microcontroller, or another similar environment. The eUICC interface 222 can be an ISO/IEC 7816 compliant hardware interface, accessed directly through GPIO pins, or accessed indirectly through the modem 208 via the +CSIM command described in ETSI TS 127 007, or by other means. The eUICC 224 can also be operatively configured to interface with the modem 208 using a physical interface 226.

In addition to providing OAI 216 to the device application 204, the orchestration agent 206 can receive local services from the device 202.

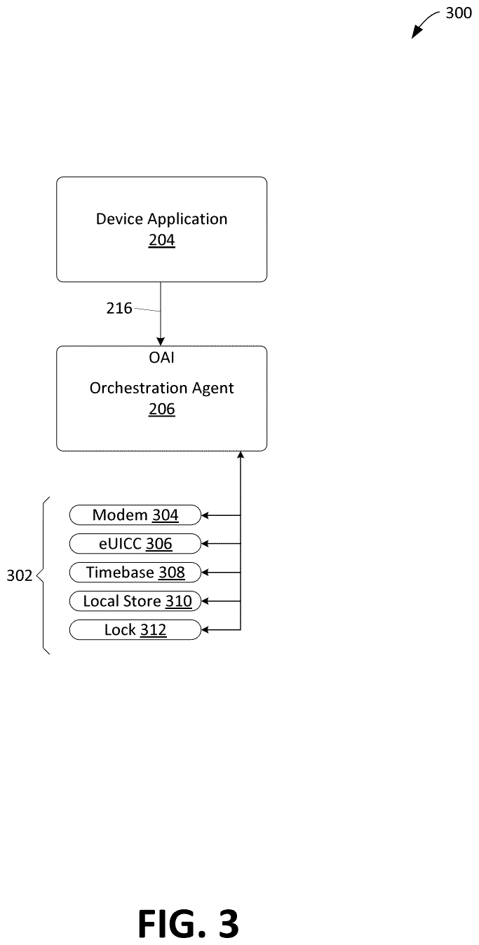

Turning now to FIG. 3, a diagram is shown illustrating an example interface environment 300 of the orchestration agent 206. In particular, the interface environment 300 shows the orchestration agent 206 operatively connected to the device application 204 via the OAI 216, as well as a plurality of supporting services and interfaces. In at least one example, the plurality of supporting services and interfaces can be referred to as the support and abstraction layer (SAL) 302.

In one example, the SAL 302 can be a library of C programming language procedures (methods) that directly link into the orchestration agent 206. In other embodiments, the SAL 302 can be implemented as a separate task, process, or hardware module, interfacing with the device application(s) 204 via shared memory, pipes, or other inter-process communication mechanism. In one example, the SAL 302 can be implemented as a kernel module, interfacing with the device application 204 using IOCTL, read, or write, or other driver calls.

The SAL 302 can include a plurality of support services. For example, the SAL 302 can include a modem service 304, a eUICC service 306, a timebase service 308, a local store service 310, and a lock service 312.

In at least one example, the modem service 304 can provide access to the modem 208 and modem interface 220. The modem access can be serialized and arbitrated between the orchestration agent 206, the device application 204, and other software and hardware elements. The eUICC service 306 can provide access to the eUICC 224 and the eUICC interface 222. In one example, eUICC 224 access can be serialized and arbitrated between the orchestration agent 206, the device application 204, the modem 208, and other software and hardware elements. In embodiments where the orchestration agent 206 accesses the eUICC 224 through the modem 208, for example using the +CSIM command described in ETSI TS 127 007, the modem service 304 and eUICC service 306 can share common mutexes and data structures.

In a particular example, the timebase service 308 can provide access to a UTC, GPS, or other time source for allowing the orchestration agent 206 to set software timers. The local store service 310 provides arbitrated access to the orchestration agent's local store 218 in response to the basic model of open, close, read, write, and other routines seen in the C standard library.

In one example, the Lock service 312 enables the orchestration agent 206 to acquire several device-scoped resource locks. Table 1 below includes various resource locks.

TABLE 1
Example Resource Locks

| Lock | Description |
|---|---|
| WAKE | Inhibits device from suspending or powering off |
| HUB | Protects AHI communications |
| EUICC | Protects access to a specific eUICC |

Referring to Table 1, the WAKE lock can prevent a device (such as the device 202) from powering down, suspending, or powering off. The WAKE lock can be similar in function to a power manager “WakeLock” object provided by an Android operating system environment. The HUB lock can provide protection similar to a WAKE lock; however, the HUB lock can additionally protect ongoing communications with the orchestration hub 104, for example, by ensuring a modem stays powered on and connected, inhibiting PSM and eDRX, making Ethernet or BLE available, or by taking other appropriate steps. The orchestration agent 206 can acquire a HUB lock when it expects a response from an AHI 134 method call, for example. The EUICC lock can provide the same protection as a WAKE lock, but it additionally protects ongoing communications with an eUICC, for example by keeping the eUICC powered on. The orchestration agent 206 can acquire an EUICC lock when it is using the ES10 interface or running an APDU script with the eUICC, for example, or when it needs to preserve an open logical channel within the eUICC.

In at least one example, an EUICC lock can include implicit restrictions placed on the modem hosting the EUICC. For example, an EUICC lock can require that PSM be inhibited, to prevent the modem from suspending or powering down the EUICC as part of its power saving strategy. In cases where a single eUICC serves multiple modems, such as when Multiple Enabled Profiles (“MEP”, SGP.22 v3.1 2.12) are implemented, an EUICC lock can also guard physical resources interfacing with eUICC port 0.

Locks can be acquired through a single library method with parameters describing which lock or locks are requested. An asynchronous callback hook can be used to convey the success or failure of the operation and a lock ID, which can be used later to release the lock. Acquired locks are explicitly released by a subsequent lock acquisition, or implicitly released in response to device power loss or reset.

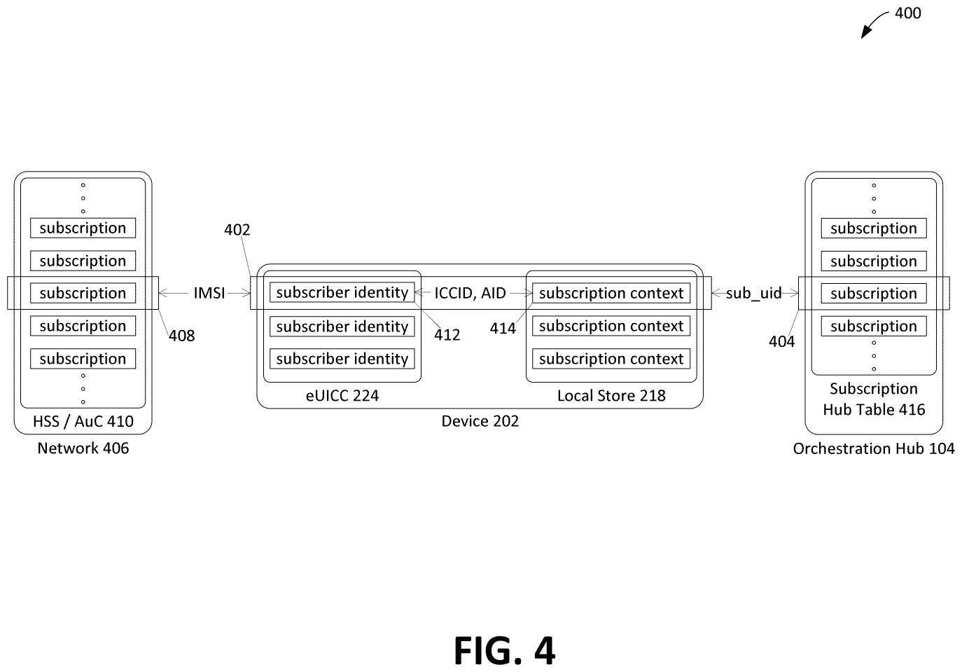

Turning now to FIG. 4, a diagram illustrating a subscription edge record 400 is shown, according to one aspect of the present disclosure. In one example, a subscription can be a set of related data structures distributed throughout a network or throughout a plurality of devices (such as the plurality of devices 108) that are all mutually linked by a common IMSI value.

In at least one example, subscription information, and/or subscription-related information, can be stored at individual devices, such as the device 202. The subscription-related information at the device 202 can be referred to as a subscription edge rows. In the present embodiment, a particular subscription edge row 402 is shown for example purposes. Subscription-related information stored in the orchestration hub 104 can be referred to as a subscription hub rows. In the present embodiment, a particular subscription hub row 404 is shown for example purposes. In certain examples, subscription rows from the connectivity manager 102 and device manager 106 can be referred to as subscription source rows. During normal operations, subscription hub rows can be asynchronously updated with information from subscription source rows. The updated subscription hub rows can be asynchronously replicated to subscription edge rows.

In one example, a network 406 can include one or more subscription rows, which can include subscription information such as phone numbers, location, service entitlements, cryptographic keys, and other data. In the present embodiment, a particular subscription row 408 is shown for example purposes. The subscription row 408 can be stored in the network's authorization center 410 (e.g., 5GC, home subscriber server (HSS), etc.). Subscription information can also be stored in a subscription edge row 402 in a device 202 and a subscription hub row 404 stored in an orchestration hub 104. The subscription edge row 402 includes subscriber identity 412 (for example, an eSIM profile installed into an eUICC 224) and subscription context 414 (saved in a local store 218). The subscriber identity 412 and subscription context 414 are linked by two shared values, the AID of the eSIM profile's ISD-P, which is unique to the eUICC, and the ICCID of the profile, which is universally unique. The subscription edge row 402 relates to the subscription information in the network's 406 home location register (HLR) by a common IMSI value, stored in both the subscriber identity 412 and network authorization center 410, and also possibly distributed into other parts of an overall cellular network 406. The subscription edge row 402 relates to a subscription hub row 404 in a subscription hub table 416 by a common sub_uid integer value, together with a row revision (sub_rev), and a synchronization state value (sync_state). Example synchronization state values are listed below in Table 2.

TABLE 2
Example Sync States.

| Sync State | Description |
|---|---|
| CONFIRMED | The row has been stored and confirmed at the device |
| WORKING | The row is being sent to the device |
| LEADING | The row has changes pending that have not been sent |
| | to the device |

Referring to Table 2, synchronization state (sync_state) values are shown, describing the state of the replication process between a subscription hub row 404 and its corresponding subscription edge row 402. The CONFIRMED state can mean that the subscription hub row 404 has been written to the corresponding subscription edge row 402 and acknowledged by the device 202. The WORKING state can mean that the subscription hub row 404 is in the process of being written to its corresponding subscription edge row 402, but has not yet been confirmed. The LEADING state can mean that changes are present in the subscription hub row 404 that have not yet been sent to the device 202.

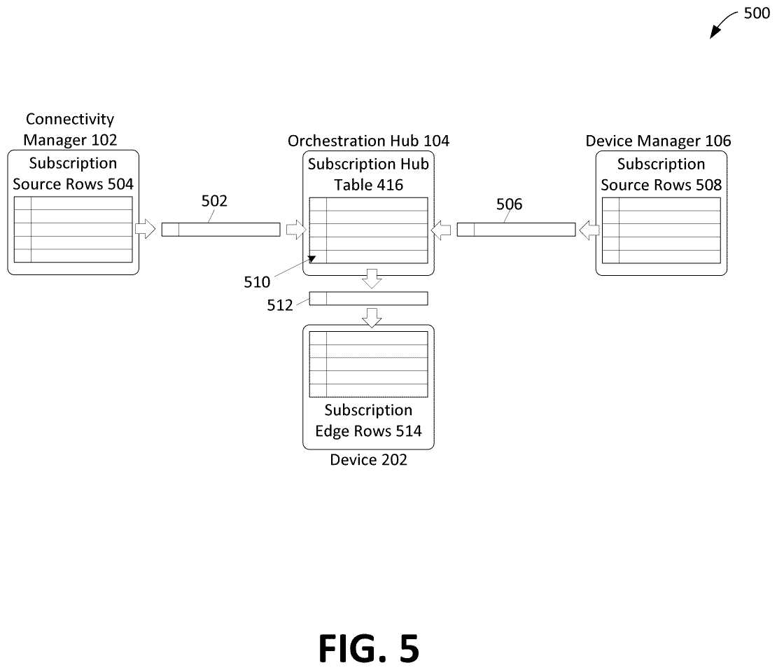

FIG. 5 is a diagram illustrating a two-stage asynchronous subscription row replication process 500. As is discussed throughout the present disclosure, an orchestration hub 104 is operatively configured to merge (combine) subscription information from one or more connectivity managers 102 and one or more device managers 106 for updating corresponding subscription information at edge devices (such as the device 202). As shown in the subscription row replication process 500, a connectivity manager 102 forwards one or more subscription source rows 502 from a plurality of subscription source rows 504 to an orchestration hub 104, asynchronously, as needed. In one example, a device manager 106 can forward one or more subscription source rows 506 from a plurality of subscription source rows 508 to the orchestration hub 104, asynchronously, as needed. As subscription source row updates are received, the orchestration hub 104 can merge the subscription source rows 502 and 506 into subscription hub rows 510 in a subscription hub table 416. As this process makes changes to subscription hub rows 510, the orchestration hub 104 transmits updated subscription information 512 to corresponding subscription edge rows 514. In one example, the corresponding subscription edge rows 514 can be stored in a device 202, or in any device of the plurality of devices 108.

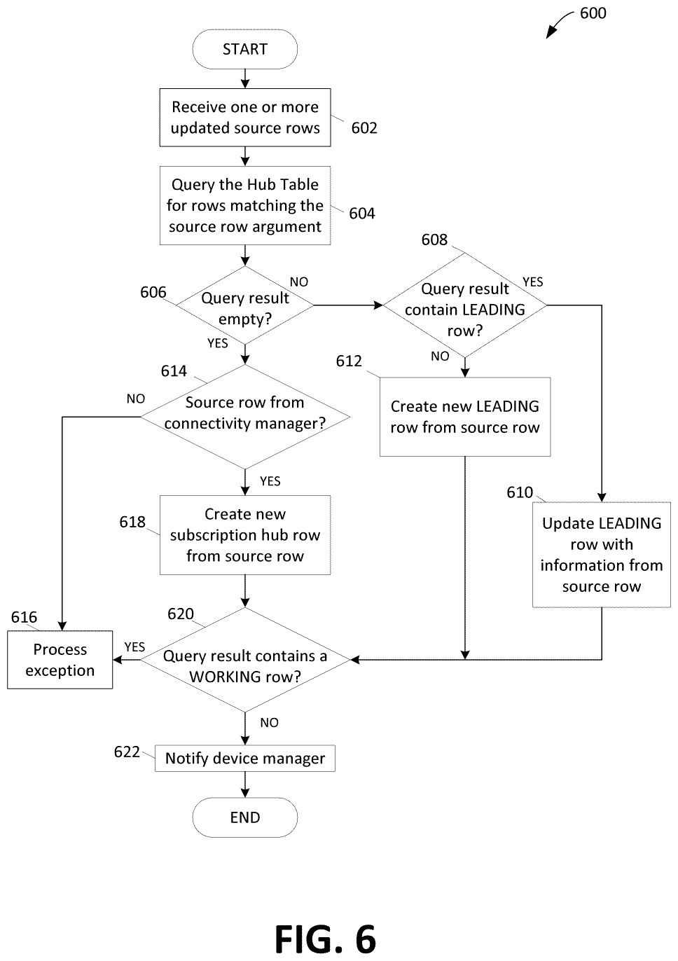

FIG. 6 is a flowchart of an example subscription source row update process 600. The process 600 illustrates the procedure performed by an orchestration hub (such as the orchestration hub 104) when it receives one or more updated subscription source rows (such as the updated subscription source rows 502 and 506). The process 600 can start at step 602 where the system receives one or more updated source rows. At step 604, the orchestration hub queries the subscription hub table for rows that match the received updated source rows. In one example, step 604 can include querying the subscription hub table for source row subscription information matching the received updated source rows.

At step 606, the system determines whether the query result is empty. If the query result is not empty, the process 600 proceeds to step 608. At step 608, the system determines whether the query result contains a LEADING row. If the query result contains a LEADING row, the process 600 proceeds to step 610 where the orchestration hub updates the LEADING row with information/fields from the source row.

If, at step 608, the system determines that the query results do not include a LEADING row, the process 600 can proceed to step 612. At step 612, the orchestration hub creates a new LEADING row by combining (a) the row with the highest sub_rev value in the query result, (b) this highest sub_rev value incremented by 1, and (c) fields from the source row.

Referring back to step 606, if the system determines that the query result is empty, the process 600 proceeds to step 614 to determine whether the updated source row is from a connectivity manager. In general, at step 614, if the system determines that the query result is empty, it can be determined that the source row represents a new subscription to the orchestration hub, which should only arrive from a connectivity manager. At step 614, if it is determined that the update is not from a connectivity manager, then the process 600 can proceed to step 616, where an exception is processed and the process 600 ends. However, at step 614, if it is determined that the updated source row is from a connectivity manager, the process 600 can proceed to step 618, where the orchestration hub creates a new subscription hub row with sync_state=LEADING, sub_rev=0, and a unique sub_uid. In various examples, the orchestration hub can accepts new subscription rows from device managers, as placeholder subscription rows, to be completed, populated, or updated at a later time by corresponding source rows from connectivity managers.

In response to the steps 618, 612, and/or step 610, the process 600 can proceed to step 620. At step 620, the orchestration hub can determine whether the query result contains a WORKING row. If a WORKING row exists, the process 600 can proceed to step 616 to process an exception and to terminate the process. If a WORKING row does not exist, the process 600 can proceed to step 622 where the orchestration hub notifies the device manager that an APDU may be ready for the affected device. At this point, the source row has been merged into the subscription hub table.

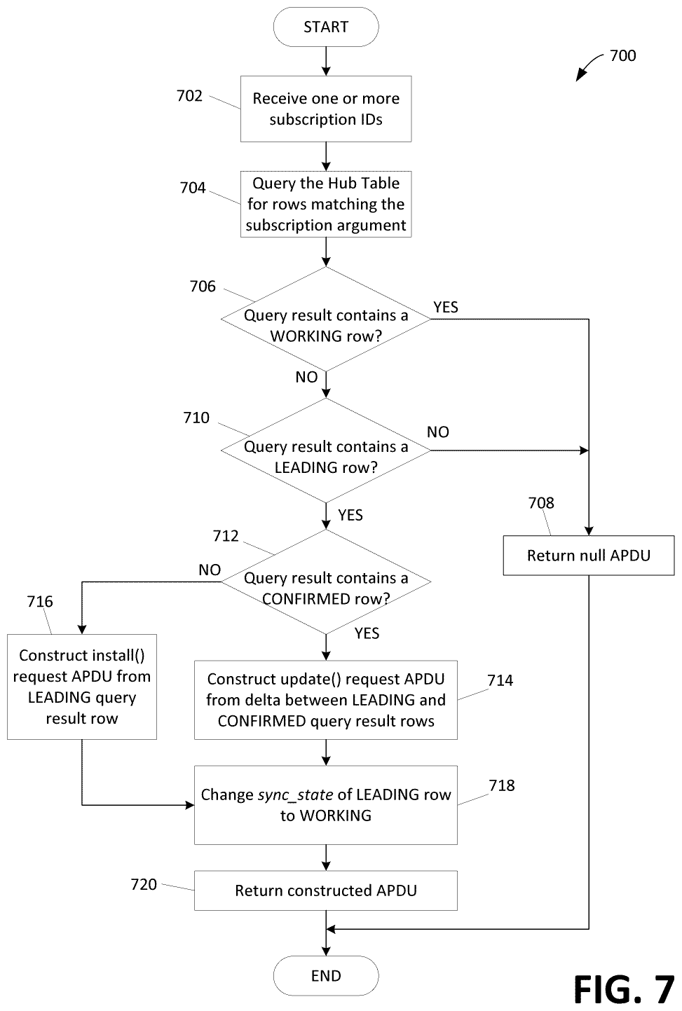

FIG. 7 is a flowchart of an example edge row update process 700. In one example, and in response to notifying a device manager regarding an updated source row, a device manager may invoke an OHI GetApdu ( ) method to generate and return an APDU for the affected device. The orchestration hub processes the GetApdu ( ) method call, in part, by effectively iterating through subscription hub rows associated with the device and initiating the process 700, with each subscription ID as an argument. In one example, the process 700 can begin at step 702 where the orchestration hub receives a subscription ID passed as an argument.

At step 704, the orchestration hub queries the subscription hub table for rows that match the subscription ID argument received at step 702.

At step 706, the orchestration hub determines whether the query result includes a WORKING row. If, at step 706, the query result includes a WORKING row, then the process 700 proceeds to step 708, where procedure returns a NULL APDU value and the process 700 ends. If, at step 706, it is determined that the query does not include a WORKING row, then the process 700 proceeds to step 710 where the orchestration hub determines whether the query result includes a LEADING row. If the query result does not include includes a LEADING row, then the procedure returns a NULL APDU value at step 708. If at step 710, it is determined that the query includes a LEADING row, the process 700 proceeds to step 712.

At step 712, the orchestration hub determines whether the query results include a CONFIRMED row. If the query results include a CONFIRMED row, then the orchestration hub, at step 714, generates an update ( ) AHI request APDU from the delta between the LEADING and CONFIRMED result rows. Otherwise, the process 700 proceeds to step 716, where the orchestration hub generates an install ( ) AHI request APDU from the LEADING row.

In response to performing both steps 714 and 716, the process 700 proceeds to step 718, where the orchestration hub changes the sync_state of the LEADING row to WORKING. Further, at step 720, orchestration hub returns the constructed APDU to the caller, which breaks out of the iterative loop and passes the APDU to the device manager as part of the GetApdu ( ) return value. The device manager can then forward the APDU to the device as an AHI update ( ) or AHI install ( ) method call.

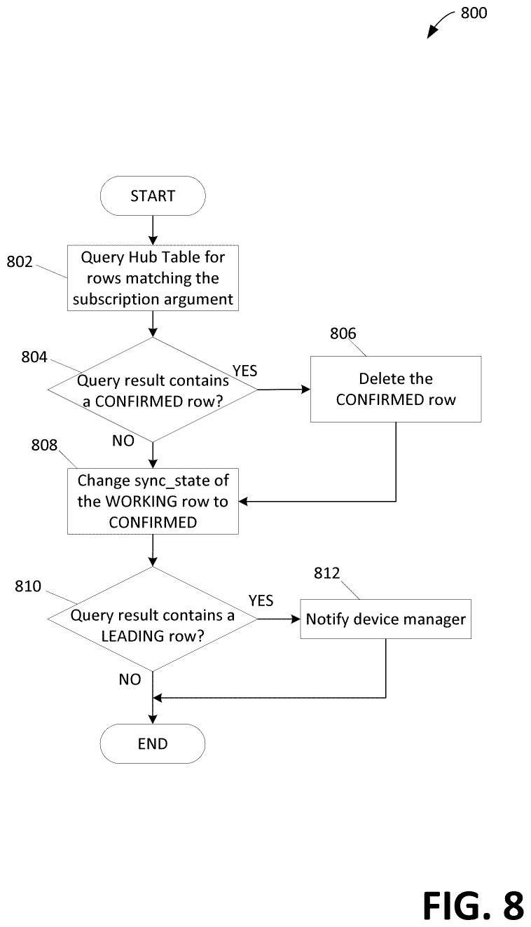

FIG. 8 is a flowchart of an example edge row update process 800. In at least one example, when the AHI install ( ) or update ( ) method is completed (as discussed above in connection with the process 700 of FIG. 7), the device manager invokes an OHI PutApdu ( ) method with the response APDU. The orchestration hub processes the PutApdu ( ) method call, in part, by initiating the process 800, with the subscription ID as an argument.

In one example, the process 800 can start at step 802, where the orchestration hub queries the subscription hub table for rows that match the subscription argument. At step 804, the orchestration hub determines whether the query result includes a CONFIRMED row. If, at step 804 the orchestration hub determines the query result includes a CONFIRMED row, the process 800 proceeds to step 806 where the orchestration row deletes the CONFIRMED row. If, at step 804 the orchestration hub determines the query result does not include a CONFIRMED row, the process proceeds to step 808.

At step 808, and in response to step 804 or 806, the orchestration hub changes the sync_state field of the WORKING row to CONFIRMED. At step 810, if it is determined that the query result does not include a LEADING row, the process 800 can end. At step 810, if the query result includes a LEADING row, the process 800 proceeds to step 812 where the orchestration hub notifies the device manager that an APDU may be ready for the affected device. At this point, the response to the AHI install ( ) or update ( ) method call has been processed and the procedure ends.

Throughout the present disclosure, subscription rows, such as subscription hub rows, are described in terms of their constituent fields. Table 3, shown below, includes a plurality of subscription hub row fields and their corresponding sources, according to various aspects of the present disclosure.

TABLE 3
Example Subscription Hub Row Fields and Sources

| Field | Description | Source |
|---|---|---|
| sub_uid | Subscription ID | OH |
| sub_rev | Subscription revision | OH |
| state | Subscription state | CM |
| edge_state | Subscription Edge Row state | OA |
| sync_state | Synchronization State | OH |
| flags | Subscription flags | CM |
| cm_base_rank | Subscription Base Ranking Value | CM |
| dm_base_rank | Subscription Base Ranking Value | DM |
| cm | Connectivity Manager ID | OH |
| cm_id | Connectivity Manager Subsciption ID | CM |
| iccid | Integrated circuit card identifier of | CM |
| | the eSIM profile | |
| eid | ID of eUICC containing the eSIM profile | OA or OH |
| dp_address | Activation code SM-DP+ address | CM |
| ac_token | Activation code token | CM |
| cc | Confirmation code | CM |
| ins_script | Install script ID | CM |
| upd_script | Update script ID | CM |
| ppr1_consent | Consent for PPR1 | DM |
| ppr2_consent | Consent for PPR2 | DM |
| pdp | PDP context parameters | CM |
| imsi_count | The number of IMSIs contained in the | CM |
| | subscription | |
| band_list | Application band list of subscription | CM |
| cm_plmn_rank | PLMN/IMSI rank | CM |
| dm_plmn_rank | PLMN/IMSI rank | DM |
| geo | Geographic coverage area | CM |
| cm_attributes | Connectivity manager supplied attribute | CM |
| | values | |
| dm_attributes | Device manager supplied attribute values | DM |
| cm_extdata | Connectivity manager supplied extended | CM |
| | data | |
| dm_extdata | Device manager supplied extended data | DM |

Referring to Table 3 above, a subscription hub row is described in terms of its constituent fields. In Table 3, the “Field” column includes field names, the “Description” column includes field descriptions, and the “Source” column indicates which element may supply the data. Possible “Source” column values include OH (orchestration hub), OA (orchestration agent), CM (connectivity manager), DM (device manager), DP (SM-DP+). The sub_uid field includes an integer ID of the subscription, unique within the orchestration hub, and the sub_rev field includes the current revision of the subscription hub row. The state field describes the subscription state as detailed in Table 4. The edge_state field describes the subscription edge row state. The sync_state field describes the synchronization state between the subscription hub row and its corresponding subscription edge row 402 as summarized in Table 2 and explained above. The cm_base_rank field includes a base ranking value for the subscription from the connectivity manager, and the dm_base_rank field includes a base ranking value for the subscription from the device manager. Ranking values are lower for more preferable subscriptions and higher for less preferable subscriptions. The cm field identifies the connectivity manager providing the subscription, and the cm_sub_id identifies the subscription within the connectivity manager. The iccid field identifies the eSIM profile related to the subscription. The dp_address contains the URL of an SM-DP+ server to be used for eSIM profile download (SGP.22 v2.4 4.1). The ac_token and cc fields describe the activation code token (SGP.22 v2.4 4.1) and confirmation code (SGP.22 v2.4 4.7), respectively, to be during an SM-DP+ profile download. The ins_script identifies a script to be used to install the subscriber identity. If this value is included, it implies an in-factory profile provisioning (“IFPP”) type installation process and the dp_address, ac_token, and cc fields should be ignored. The upd_script describes the most recent update script required for profile content management. The ppr2_consent and ppr2_consent fields indicate whether consent is granted for PPR1 and PPR2 (SGP.22 v2.4 2.4.1). The pdp field specifies the PDP context values to use with the subscription, presented as a list of structures, each including a context ID, APN value, IP type, and other information required by the +CGDCONT command described in ETSI TS 127 007, as well as a maximum MTU sizes and other parameters. The band_list field describes the list of frequency bands that may be required to use the subscription, included as a list of band numbers from the LTE frequency bands, the NR frequency bands 1, 2, NT1, NT2, and other bands as may apply. The cm_plmn_rank and dm_plmn_rank fields each include a list of entries, each entry including MCC, MNC, and optional imsi_ordinal and rank values. The MCC and MNC together describe a mobile network, such as may be seen by the +COPS=? command described in ETSI TS 127 007. The imsi_ordinal value, if present, describes an IMSI that may be used to attach to the network. If imsi_ordinal is not present, then any IMSI of the subscription may be used, or the eSIM profile may automatically select the IMSI. The rank value, if present, overrides the base_rank value as the ranking value for the subscription/IMSI/MCC/MNU combination. In general, MCC/MNU combinations present in the cm_plmn_rank field are recommended for use with the subscription, and values present in dm_plmn_rank override matching rank values present in cm_plmn_rank. The geo field includes a list of geographical regions, such as an MCC value, or a circle or trapezoid mapped onto the surface of the Earth, along with imsi_ordinal and an inside boolean value determining whether the region is inclusive or exclusive. When the device's position meets the geographical requirement, the imsi_ordinal, if present, describes an IMSI that may be used with the subscription. If imsi_ordinal is not present, then any IMSI may be used with the subscription or the eSIM profile may automatically select an IMSI.

The cm_attribues field describes a list of integer attributes, which may be used to conceptually join the subscription to external data structures supplied by the connectivity manager. These values may be global, coordinated values, or they may be scoped values specific to a connectivity manager. The dm_attributes field contains a list of integer attributes, which may be used to conceptually join to the subscription to external data structures supplied by the device manager. Like the cm_attributes field, dm_attributes values may be global, coordinated values, or they may be scoped values specific to a device manager. Examples of cm_attributes usage may include identifying device-side APDU API models for the eSIM profile, identifying alternate cost models involving system access fees or prepaid plans, or identifying other characteristics. Examples of dm_attibutes usage may include identifying device-specific ranking algorithms, tags to make sure device or modem firmware revisions are up to a certain level before using the subscription, tags to ensure certain randomization intervals for inbound data, or other information. The cm_extdata field may contain raw data supplied by and specific to the connectivity manager, and the dm_extdata field may contain raw data supplied by and specific to the device manager, using global, coordinated formatting, or formatting specific to a connectivity manager or device manager, respectively.

Table 4, as shown below, illustrates possible state field values. The STOCK state indicates that the subscription is provisioned in the network but not yet available for use. The READY state indicates that the subscription is available for use but not yet generating usage charges. The ACTIVE state means that the subscription is available for use and generating usage charges. SUSPEND means the subscription is temporarily unavailable for use, and TERMINATED means that the subscription has been de-provisioned.

TABLE 4
Example State Field Values.

| State | Description |
|---|---|
| STOCK | Subscription has not yet been activated. |
| READY | Subscription is active but has not yet |
| | incurring cost. |
| ACTIVE | Subscription is active. |
| SUSPEND | Subscription has been suspended. |
| TERMINATED | Subscription has been terminated. |

Table 5, as shown below, illustrates possible subscription context and subscription edge row field values.

TABLE 5
Example Subscription Context and Subscription
Edge Row Field Values.

| Field | Description | Source |
|---|---|---|
| sub_uid | Subscription ID | OH |
| sub_rev | Subscription revision | OH |
| state | Subscription state | CM |
| edge_state | Subscription Edge Row state | OA |
| flags | Subscription flags | CM |
| base_rank | Subscription Base Ranking Value | CM or DM |
| iccid | Integrated circuit card identifier of | CM |
| | the eSIM profile | |
| aid | Application ID of ISD-P containing the | EU |
| | sSIM profile | |
| eid | ID of eUICC containing the eSIM profile | OA |
| ac_token | Activation code token | CM |
| cc | Confirmation code | CM |
| ins_blob | Install script blob ID | OH |
| upd_blob | Update script blob ID | OH |
| ppr1_consent | Consent for PPR1 | DM |
| ppr2_consent | Consent for PPR2 | DM |
| pdp | PDP context parameters | CM |
| imsi_count | The number of IMSIs contained in the | CM |
| | subscription | |
| band_list | Application band list of subscription | CM |
| plmn_rank | PLMN/IMSI rank | CM and DM |
| geo | Geographic coverage area | CM |
| cm_attributes | Connectivity manager supplied attribute | CM |
| | values | |
| dm_attributes | Device manager supplied attribute values | DM |
| cm_extdata | Connectivity manager supplied extended | CM |
| | data | |
| dm_extdata | Device manager supplied extended data | DM |

As shown in Table 5, the “Field” column includes field names, the “Description” column contains field descriptions, and the “Source” column indicates which element may supply the data. Possible “Source” column values include OH (orchestration hub), OA (orchestration agent), CM (connectivity manager), DM (device manager), DP (SM-DP+122), and EU (eUICC 224). The sub_uid and sub_rev field includes an integer ID and revision of the subscription, as described in Table 3 for the subscription hub row. The base rank field includes the value of dm_base_rank from Table 3, or cm_base_rank from Table 3 if dm_base_rank is not present. The iccid and aid fields both match the subscription context to the subscription identity in the eUICC identified by the eid field. The ins_blob and upd_blob refer to the ins_script and upd_script fields in Table 2, using blob identifiers compatible with an AHI get_blob ( ) method. Binary large objects, or “BLOBs,” will be discussed in greater detail below. The plmn_rank field includes an aggregate of cm_plmn_rank and dm_plmn_rank such that all the cm_plmn_rank entries are present, with rank values overridden by corresponding MCC/MNC/imsi_ordinal entries in dm_plmn_rank field. Other fields in Table 5 match the identically named fields in Table 3.

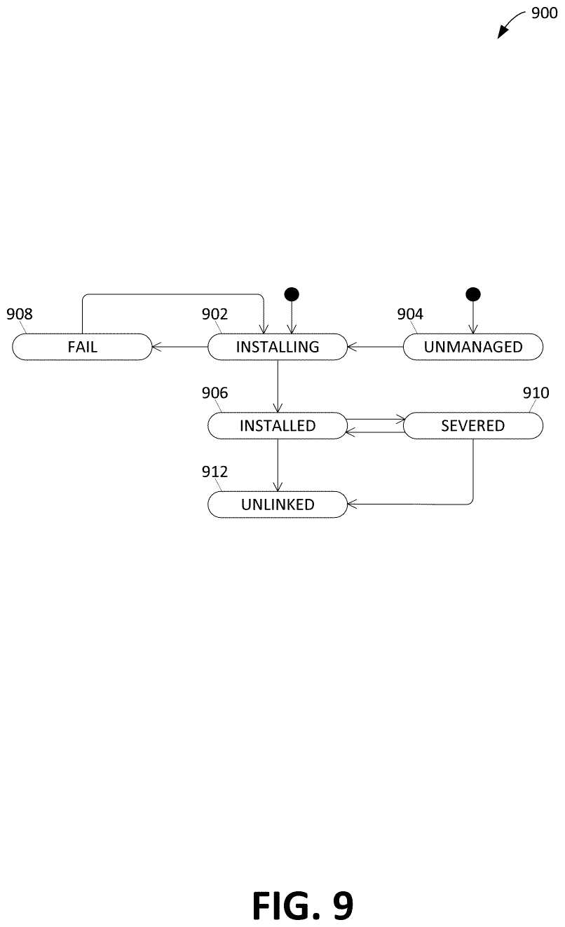

FIG. 9 is an example subscription edge record state diagram 900. In one example, a subscription can have two possible initial states: INSTALLING 902 when a subscription edge record is initially created by an AHI install ( ) method call (described in more detail below), and UNMANAGED 904 when a subscription is installed locally using a device LPA or preloaded by an EUM. While a subscription is in the INSTALLING 902 state, the orchestration agent securely installs the subscriber identity. If the installation process completes successfully, the edge state transitions to INSTALLED 906. If the installation process fails, the edge state transitions to FAIL 908. A failed download may be retried by the orchestration agent, returning the state to INSTALLING 902. The SEVERED state 910 means that the subscription context is populated but the corresponding subscriber identity is missing. The state may transition from INSTALLED 906 to SEVERED 910 after an eUICC is removed from a device. For example, a technician removing an eUICC from device A and inserting it into device B may result in a SEVERED 910 subscription edge record in device A and an UNMANAGED 904 subscription edge record in device B. The state can move from INSTALLED 906 or SEVERED 910 to UNLINKED 912 if an AHI delete ( ) method call is made. When the state is UNLINKED 912, the orchestration agent can delete the subscription edge row from the eUICC 224 and store 218 when other local conditions permit.

When a subscription edge record starts in or transitions to the UNMANAGED state 904, the orchestration hub and orchestration agent may be able to transition it to the INSTALLED state 906. For example, if the device and subscription exist in the same orchestration hub account, and if an AHI pathway exists between the orchestration hub and device agent, the orchestration hub may locate the subscription and call the AHI update ( ) method to restore its subscription context information at the device. A person skilled in the art will recognize that this mechanism can manage subscription context with UICCs as well as eUICCs. A UICC inserted into a device will appear as an UNMANAGED 904 subscription, which the hub may find and download appropriate subscription context.

Subscription templates are discussed throughout the present disclosure. In one example, a subscription template (“template”) describes the class or type of a subscription, such as a particular MNO or MVNO, data plan, coverage area, and other attributes. Subscription templates can be provided by connectivity managers and can be enhanced by device managers. Subscription templates can be used as a parameter when new subscriptions are acquired through OHI and CMI. Example subscription template fields are shown below in Table 6.

TABLE 6
Example Subscription Template Fields

| Field | Description | Source |
|---|---|---|
| tem_id | Template ID | OH |
| cm | Connectivity Manager ID | OH |
| cm_id | Connectivity Manager Template ID | CM |
| cm_name | Connectivity Manager Template Name | CM |
| cm_desc | Connectivity Manager Template Description | CM |
| dm_base_rank | Base subscription rank | DM |
| dm_plmn_rank | PLMN/IMSI rank | DM |
| ppr1_consent | Consent for PPR1 | DM |
| ppr2_consent | Consent for PPR2 | DM |
| dm_attributes | Device manager supplied attribute values | DM |
| dm_extdata | Device manager supplied extended data | DM |

In one example, a subscription template can be described in terms of its constituent fields. As shown in Table 6, the “Field” column includes field names, the “Description” column includes field descriptions, and the “Source” column indicates which element may supply the data. Possible “Source” column values include OH (orchestration hub), CM (connectivity manager), and DM (device manager). The cm field includes an identifier of connectivity manager supplying the template. The cm_id field includes the connectivity manager's ID for the template, the cm_name field includes the unique name given to the template by the connectivity manager, and the cm_desc includes a description of the template from the connectivity manager. The remaining fields are copied from the template to the subscription hub row when it is created (for example, following CMI AcquireSubscription and ReadSubscription method invocations as explained in more detail below) with fields from the template copied into identically named fields in Table 3.

Moreover, aspects of the present disclosure include use of secure elements, trusted execution environments, secure enclaves, and other security structures. In particular, a subscriber identity can be matched to a specific eUICC within a secure element. Additionally, in some cases, the underlying subscription may be eligible for use by a specific modem (but not others). This interdependence between subscription, modem, and eUICC can begin during the Common Mutual Authentication Procedure (SGP.22 v2.4 3.1.2, SGP.22 v3.1 3.0.1, and SGP.32 v3.2 3.2.2), and may begin earlier, such as when API calls used to retrieve Activation Codes require IMEI and EID parameters, or prior to an EUM preloading an eSIM profile into an eUICC.

Devices may include multiple modems to enable use of different, incompatible radio technologies, different radio bands, or for other reasons. Devices may include multiple eUICCs for component-level redundancy or for other reasons. In examples where a subscription edge record is to be installed into a device with multiple modems or multiple eUICCs, installation instructions must describe the destination device, modem, and eUICC.

In examples where subscriptions are installed into groups of devices with multiple modems and/or multiple eUICCs, the illustrative embodiment may identify multiple destination eUICCs with a group-wide identifier, including a list of device identifiers, a single modem_ordinal parameter to identify the modem on each device, and a single modem_slot parameter to identify the eUICC on each device. In at least one example, this group abstraction permits a separation of concerns between an orchestration hub and a device manager, enabling the device manager to describe a campaign at a device level without identifying individual eUICC EIDs.

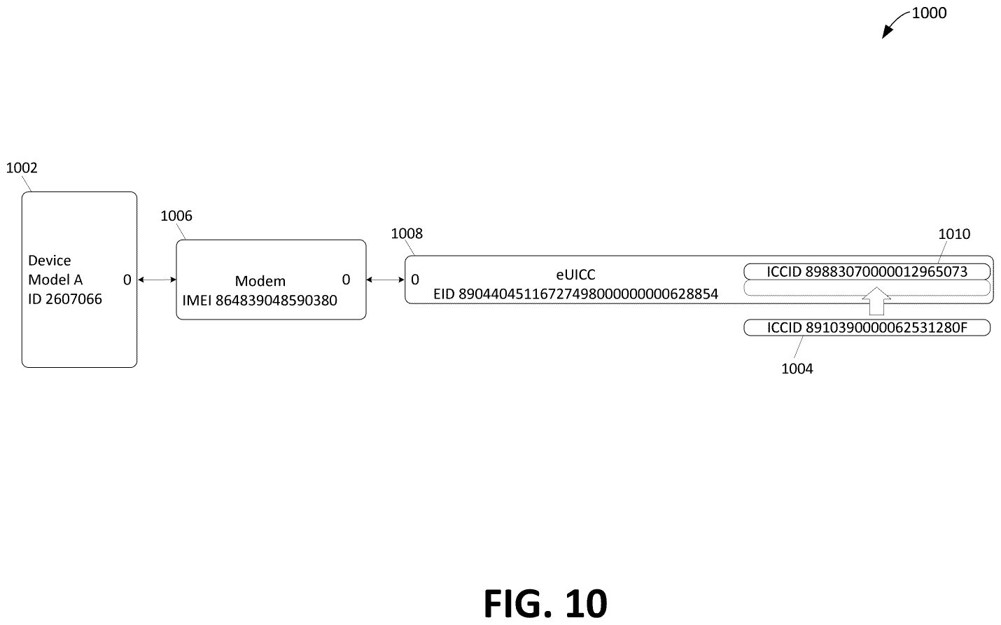

FIG. 10 is a diagram 1000 illustrating an example subscription installation. As shown in the diagram 1000, an example device 1002 of type Model A with a device_id of “2607066” is depicted, captured in the process of installing subscription 8910390000062531280F 1004. Device 1002 includes a single modem 1006 with a single SIM slot connected to an eUICC 1008. The destination of subscription 8910390000062531280F 1004 is described with a modem_ordinal value of 0, and a modem_slot value of 0. It can be noted that subscription 89883070000012965073 1010 could also have been installed previously using a modem_ordinal value of 0 and a modem_slot value of 0.

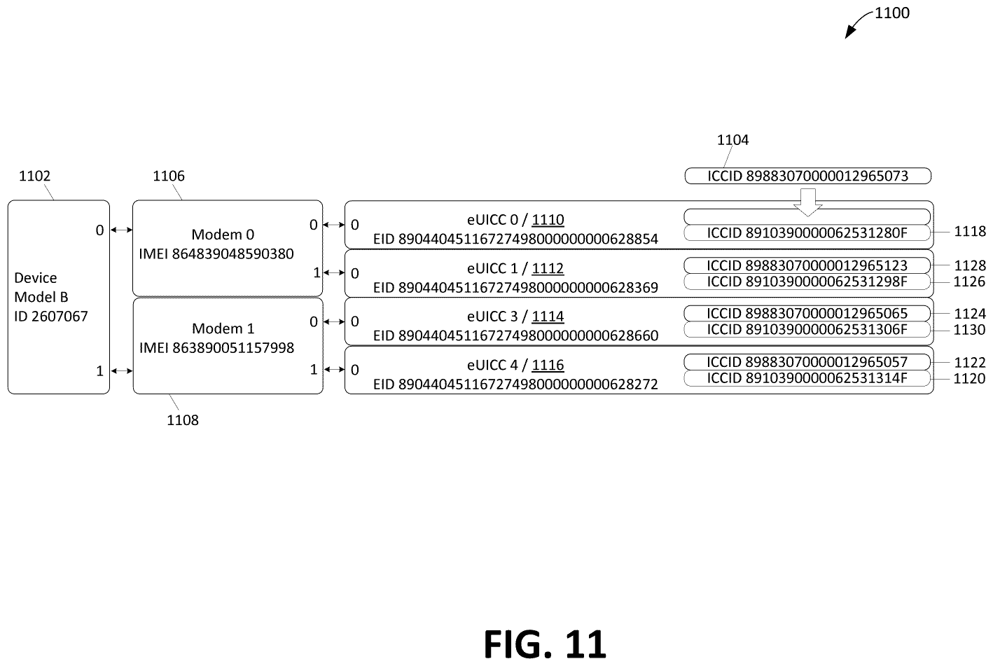

FIG. 11 is a diagram 1100 illustrating an example subscription installation. As shown in the diagram 1100, an example device 1102 of type Model B with a device_id of “2607067” is depicted, captured in the process of installing subscription 89883070000012965073 1104. Device 1102 includes two modems, modem 0 1106 and modem 1 1108. Modem 0 1106 has two SIM slots, slot 0 connected to eUICC 0 1110 and slot 1 connected to eUICC 1 1112. Modem 1 1108 likewise has two SIM slots, slot 0 connected to eUICC 3 1114 and slot 1 connected to eUICC 4 1116. The destination of subscription 1104 is described with a modem_ordinal value of 0, and a modem_slot value of 0. It can be noted that subscription 8910390000062531280F 1118 could also have been installed previously using a modem_ordinal value of 0 and a modem_slot value of 0, while subscription 8910390000062531314F 1120 could have been installed previously using a modem_ordinal value of 1 and a modem_slot value of 1.

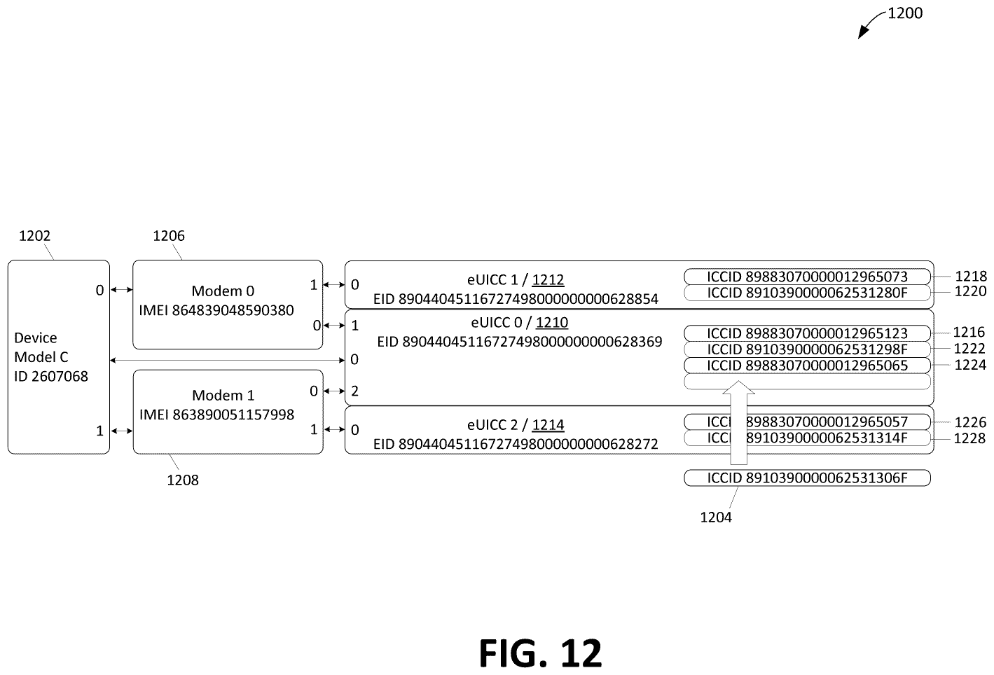

FIG. 12 is a diagram 1200 illustrating an example subscription installation. As shown in the diagram 1200, an example device 1202 of type Model C with a device_id of “2607068” is depicted, captured in the process of installing subscription 8910390000062531306F 1204. Device 1202 includes two modems, modem 0 1206 and modem 1 1208. Modem 0 1206 has two SIM slots, slot 0 connected to eUICC 0 1210 and slot 1 connected to eUICC 1 1212. Modem 1 1208 likewise has two SIM slots, slot 0 also connected to eUICC 0 1210 and slot 1 connected to eUICC 2 1214. Since eUICC 0 is MEP-capable, the destination of subscription 1204 could be described with a modem_ordinal value of 0 and a modem_slot value of 0, or a modem_ordinal value of 1 and a modem_slot value of 0. It can be noted that subscription 89883070000012965123 1216 could also have been installed previously using a modem_ordinal value of 0 or 1 and a modem_slot value of 0, while subscription 89883070000012965073 1218 could have been installed previously using a modem_ordinal value of 0 and a modem_slot value of 0.

In at least one example, the system disclosed herein can include a script in the process of installing or updating a subscription edge row. A script can be a set of command APDUs (C-APDUs) configured to be sent directly to an eUICC by an orchestration agent, which can result in a set of corresponding response APDUs (R-APDUs) from the eUICC as well as changes within the eUICC. In one example, scripts may be used to install profiles (“in-factory profile provisioning”) or modify previously installed profiles (“profile content management”). For example, an update operation may include a change in the PLMN list and also a corresponding change to the eSIM profile such as adding, replacing, or remove an IMSI. When running a script, the orchestration agent can take on a role similar to the “Local Agent” as described in the GlobalPlatform SE RAM protocol.

Further, aspects of the present disclosure can include binary large objects, or “BLOBs”. In one example, BLOBs are used to move data between orchestration agents and orchestration hubs when the data is too large to fit entirely into an AHI APDU. In certain examples, BLOBs can be used to contain bound profile packages, scripts, fields required by the Common Mutual Authentication Procedure, or other information.

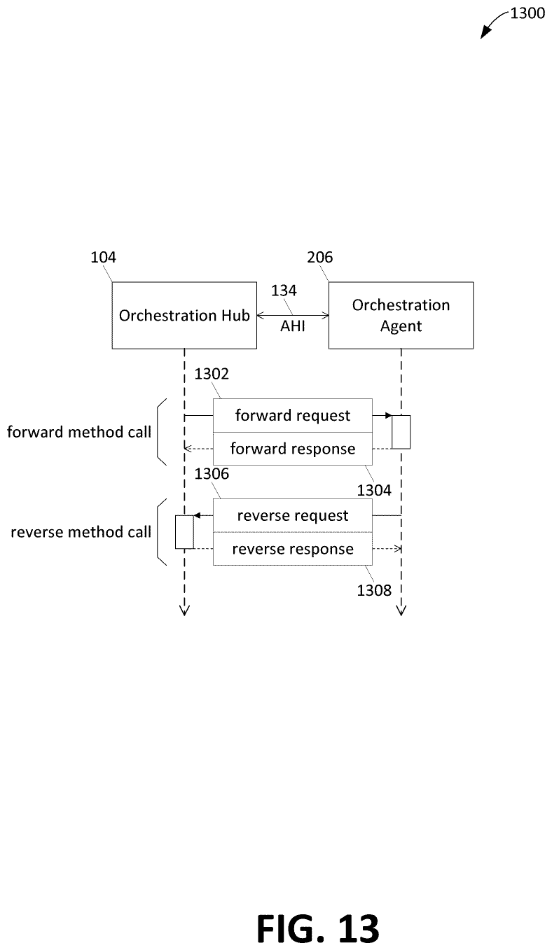

FIG. 13 is a sequence diagram illustrating an example agent-hub interface process 1300. As shown in the example agent-hub interface process 1300, forward and reverse method calls are shown between an orchestration hub 104 and an orchestration agent 206. A forward method call is initiated by a forward request APDU 1302 sent by the orchestration hub to the orchestration agent, and it is completed by a forward response APDU 1304 sent by the orchestration agent to the orchestration hub. A reverse method call is initiated by a reverse request APDU 1306 sent by the orchestration agent to the orchestration hub, and it is completed by a reverse response APDU 1308 sent by the orchestration hub to the orchestration agent.

In one example, AHI is based on bidirectional remote procedure calls (RPC) between an orchestration hub and an orchestration agent. The orchestration hub and orchestration agent may each call methods exposed by the other, with forward method calls initiated by the orchestration hub and reverse method calls initiated by the orchestration agent. Method calls can be implemented with application protocol data units (APDUs), with a request APDU conveying call arguments and a response APDU conveying call return values. In at least one example, the AHI can be operatively configured to implement a plurality of method calls, such as install ( ) update ( ) delete ( ) query ( ) and notify ( ) (a reverse method call in response to updates made to subscription edge rows/records).

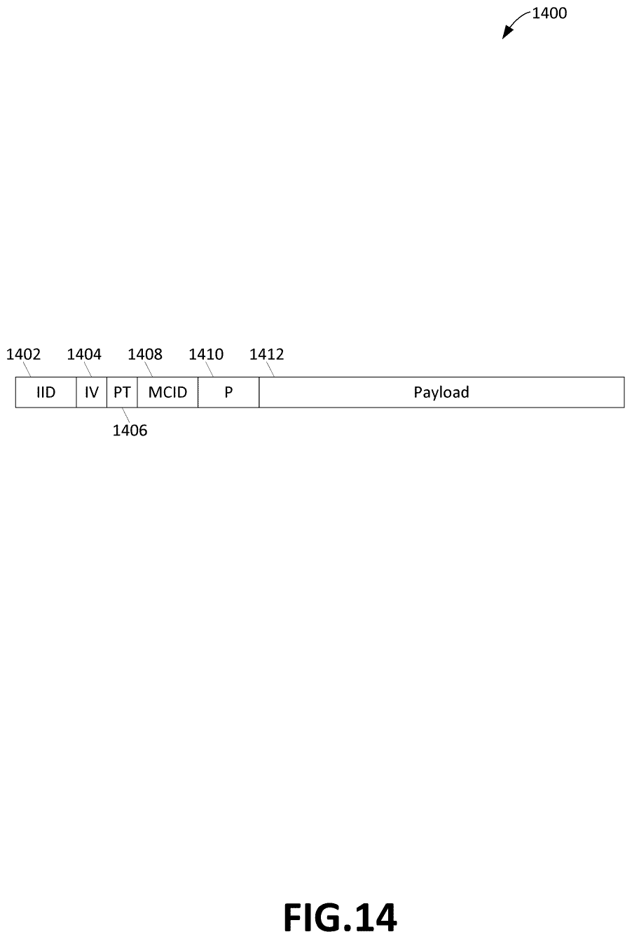

FIG. 14 is an example encoded AHI APDU 1400. As shown in the example encoded AHI APDU 1400, bytes 0 and 1 together form a 16-bit interface identifier value (IID 1402). Byte 2 specifies an interface version (IV 1404), and byte 3 specifies a payload type (PT 1406). Bytes 4 and 5 form a 16-bit method call identifier (MCID 1408). Forward method calls use MCID values in the range 0 through 32767 inclusive, while reverse method calls use MCID values in the range of 32768 through 65535 inclusive. MCIDs advance by 1 for each subsequent method call, wrapping within their range so that 65535 advances to 32768 and 32767 advances to 0. Bytes 6 and 7 include parity information (PAR 1410), and bytes 8 through the end of the APDU contain an encoded payload (payload 1412). The IID and MCID fields are encoded with the least significant byte in the lowest byte position (also known as a “little endian” byte layout).

A PT value of 0 specifies that the “Payload” field includes an encoded request or response APDU payload. A PT value of 1 specifies an error response, with the payload field containing a 32-bit integer error value encoded as four bytes, least significant byte first. A PT value of 255 specifies a window reset request, canceling any pending calls and resetting the MCID to the lowest possible number, 0 for forward transactions and 32768 for reverse transactions. In the illustrative embodiment, the IID is set to a value of 48090, the IV is set to a value of 1, and payload encoding for PT=1 is based on a proto3 specification file. The PAR field is set such that a CCITT CRC-16 value calculated from the first payload byte, to the end of the encoded APDU, followed by the first 8 bytes of the encoded APDU, is zero.

A person skilled in the art will recognize that typical remote procedure calls can fail during normal operations because of transmission problems, timeouts, synchronization problems, and for other reasons. Accordingly, AHI 134 as discussed herein includes the data structures illustrated in FIG. 14 to ensure packet integrity, enable automatic repeat requests (ARQ), and remove duplicate APDUs. In one example, the data structures illustrated in FIG. 14 are sufficient that AHI could be implemented as a simple length prefixed envelope using rudimentary transport such a UART serial link. AHI 134 could also be implemented using higher level protocols such as UDP or TCP. However, in the illustrative embodiment, AHI 134 is implemented with an explicit tunnel through OHI 118, a device manager 106, device management protocols 128, a device application 204, and OAI 216. This arrangement provides a high level of flexibility, with different device management protocols 128 used at different points in a device lifecycle. For example, device management protocols could include a wiring harness during manufacturing, Bluetooth during staging, NBIoT after deployment, and mobile ISM-band base station during recovery from a regional disaster.

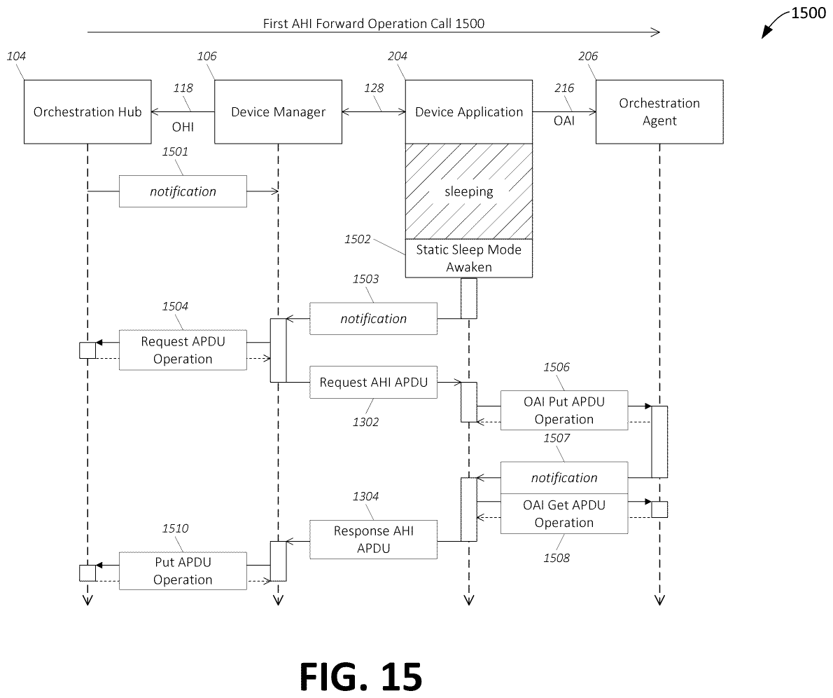

Referring now to FIG. 15, illustrated is a first AHI forward operation call 1500 with an initially unavailable device, such as the device 202 from the plurality of devices 108, according to one example of the disclosed technology. The unavailable device can include any particular device in a sleep mode and/or in a non-powered state. The device manager 106 can interface with the orchestration hub 104 via the OHI 118. The device manager 106 can communicate with the device application 204 using the device management protocols 128. The device application 204 can interface with the orchestration agent 206 using the OAI 216. In one example, the OAI 216 can be operatively configured to perform various methods for interfacing with the device application 204 and the orchestration agent 206, such as oai_start ( ) (which includes a configuration structure and callback hook), oai_stop ( ) oai_reconfig ( ) oai_get_adpu ( ) oai_put_adpu ( ) oai_get_sub ( ) oai_get_sub_list ( ) oai_query ( ) and oai_enable_sub ( ).

The AHI forward method call illustrated in FIG. 15 can begin when the device is in a powered-off state, a power-saving mode, and/or in any particular unreachable state. The orchestration hub 104 using the OHI 118 can send a notification 1501 to the device manager 106. The notification 1501 can include a notice for a pending request AHI APDU 1302 for the orchestration agent 206 of the particular device. Because the device may be unavailable, the device manager 106 can withhold a particular AHI transaction. At some arbitrary time later (e.g., several minutes or several weeks later) the device application 204 can awaken from a static sleep mode 1502 and can send a notification 1503 to the device manager 106 through the device management protocols 128. Using the OHI 118, the device manager 106 can invoke a request APDU operation 1504 and can retrieve the request AHI APDU 1302 for the device. The request APDU operation 1504 can include an operation that retrieves the next pending request AHI APDU 1302 for the particular device. The request APDU operation 1504 can include parameters such as a device ID, identifying the device that should receive the request AHI APDU 1302. The request APDU operation 1504 can return the encoded request AHI APDU 1302, where the device management protocol 128 can deliver the request AHI APDU 1302 to the specified device. The device manager 106 can transport the request AHI APDU 1302 to the device application 204 using the device management protocols 128. Upon receiving the request AHI APDU 1302, the device application 204 can forward the request AHI APDU 1302 to the orchestration agent 206 through an OAI put APDU operation 1506 available through the OAI 216. The OAI put APDU operation 1506 can include an operation that can pass the request AHI APDU 1302 received from the orchestration hub 104 to the orchestration agent 206. The orchestration agent 206 can acquire an HUB or EUICC locks 312 as appropriate to the method call represented by the request AHI APDU 1302. The orchestration agent 206 can begin processing the request AHI APDU 1302. On completion of the processing of the request AHI APDU 1302, the orchestration agent 206 can send a notification 1507 to the device application stating that the response AHI APDU 1304 is pending. If the orchestration agent 206 does not expect continued communication with the orchestration hub 104, the orchestration agent 206 can release any acquired Locks 312. The device application 204 can retrieve the response AHI APDU 1304 by calling an OAI get APDU operation 1508 available through OAI 216. The OAI get APDU operation 1508 can include an operation that returns the response AHI APDU 1304 if one is available, where the response AHI APDU 1304 can be delivered to the orchestration hub 104. The device application 204 transports the encoded response AHI APDU 1304 to the device manager 106 using device management protocols 128. Using the OHI 118, the device manager 106 can invoke a put APDU operation 1510 to deliver the response AHI APDU 1304 to the orchestration hub 104. The put APDU operation 1510 can include an operation that delivers the response AHI APDU 1304 from the device. Parameters of the put APDU operation 1510 can include but are not limited to a device ID, which can identify the device sending the response AHI APDU 1304, and the encoded APDU 1400.

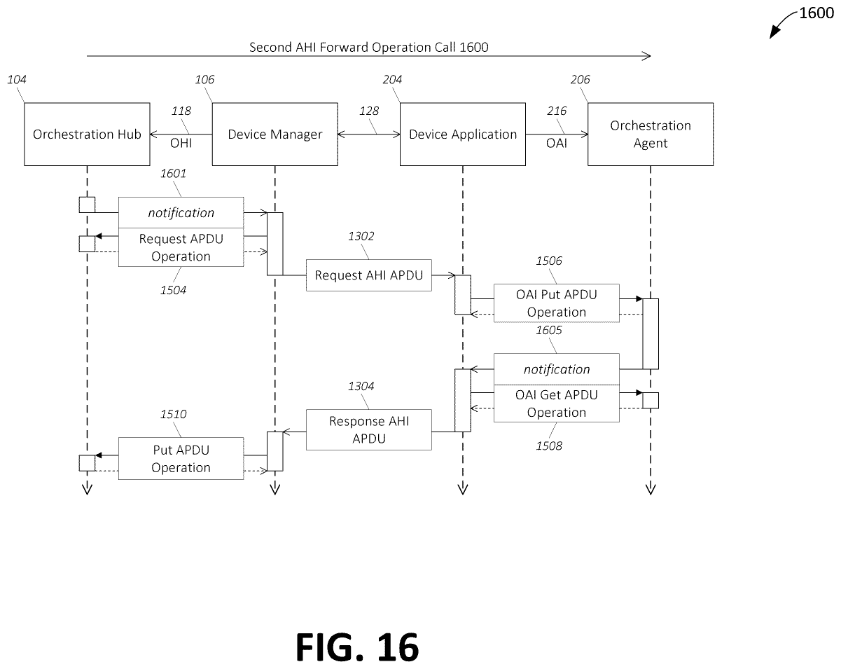

Referring now to FIG. 16, illustrated is a second AHI forward operation call 1600 with an initially available device, according to one example of the disclosed technology. The device manager 106 can interface with the orchestration hub 104 through the OHI 118. The device manager 106 can communicate with the device application 204 through the device management protocols 128. The device application 204 can interface with the orchestration agent 206 through the OAI 216. The example scenario can begin when the particular device is in a reachable state. For example, a reachable state can include but is not limited to a powered-on state, a reduced power state, and/or any particular state that can allow for open connectivity with the particular device.

Using the OHI 118, the orchestration hub 104 can send a notification 1601 to the device manager 106. The notification 1601 can include a notice that a particular AHI APDU 1400 is pending for the orchestration agent 206 of the particular device. Using the OHI 118, the device manager 106 can invoke the request APDU operation 1504 to retrieve the request AHI APDU 1302 for the device. The device manager 106 can transport the request AHI APDU 1302 to the device application 204 using the device management protocols 128. Upon receiving the request AHI APDU 1302, the device application 204 can forward the request AHI APDU 1302 to the orchestration agent 206 using the OAI put APDU operation 1506 available through OAI 216. The orchestration agent 206 can acquire a HUB or EUICC lock 312 as appropriate to the method call represented by the request AHI APDU 1302. The orchestration agent 206 can begin processing the request AHI APDU 1302. When the orchestration agent 206 finishes processing the request AHI APDU 1302, the orchestration agent 206 can send a notification 1605 to the device application 204 that a response AHI APDU 1304 is pending. If the orchestration agent 206 does not expect continued communication with the orchestration hub 104, the orchestration agent 206 can release any acquired Locks 312. The device application 204 can retrieve the response AHI APDU 1304 by calling the OAI get APDU operation 1508 available through OAI 216. The device application 204 can transport the encoded response AHI APDU 1304 to the device manager 106 using the device management protocols 128. Using the OHI 118, the device manager 106 can invoke the put APDU operation 1510 to deliver the response AHI APDU 1304 to the orchestration hub 104.

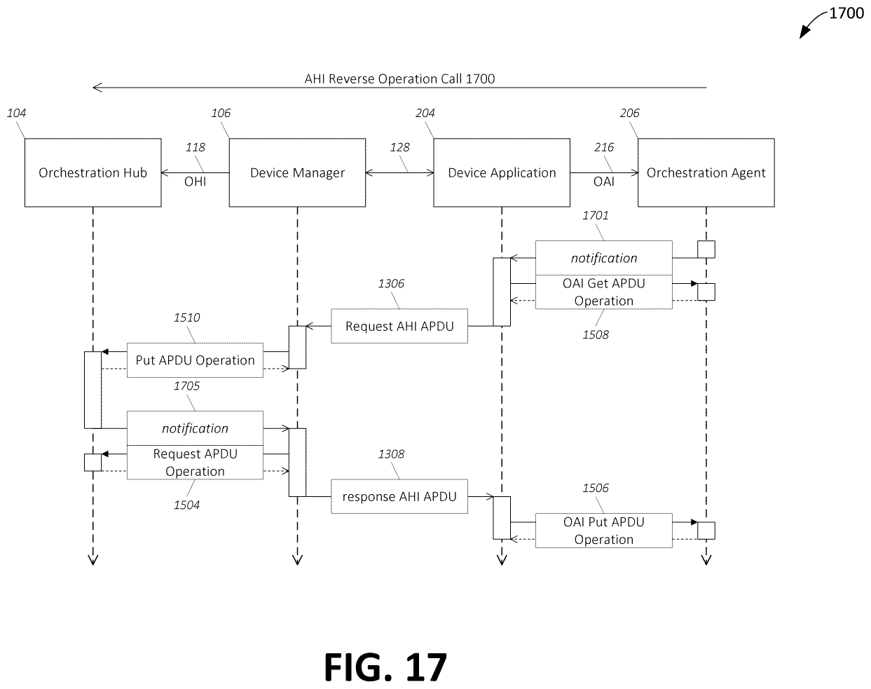

Referring now to FIG. 17, illustrated is an AHI reverse operation call 1700, according to one example of the disclosed technology. The device manager 106 can interface with the orchestration hub 104 through the OHI 118. The device manager 106 can communicate with the device application 204 through the device management protocols 128. The device application 204 can interface with an orchestration agent 206 through the OAI 216.

Using the OAI 216, the orchestration agent 206 can send a notification 1701 to the device application 204. The notification 1701 can include a notice that the request AHI APDU 1306 is pending for the orchestration hub 104. Using the OAI 216, the device application 204 can trigger the OAI get APDU operation 1508. The OAI get APDU operation 1508 can retrieve the request AHI APDU 1306 for the orchestration hub 104. The device application 204 can transport the request AHI APDU 1306 to the device manager 106 using the device management protocols 128. Using the OHI 118, the device manager 106 can invoke the put APDU operation 1510 to deliver the request AHI APDU 1306 to the orchestration hub 104. The orchestration hub 104 can process the request AHI APDU 1306. When the orchestration hub 104 finishes processing the request APDU, the orchestration hub 104 can use the OAI 216 to send a notification 1705 to the device manager 106. The notification can include a notice that the orchestration hub 104 has a response AHI APDU 1308 ready. Using the OHI 118, the device manager 106 can invoke the request APDU operation 1504 to retrieve the response AHI APDU 1308. The device manager 106 can transport the response AHI APDU 1308 to the device application 204 using the device management protocol 128. Using the OAI 216, the device application 204 can call the OAI put APDU operation 1506 to deliver the response AHI APDU 1308 to the orchestration agent 206.

Referring generally now to FIGS. 15-17, the first AHI forward operation call 1500, the second AHI forward operation call 1600, and the AHI reverse operation call 1700 can synchronize the device managers 106 and the one or more devices, thereby reducing the rate of transaction interruptions from loss of signal, loss of power, sleep modes, and other adverse events. While these types of interruptions will still occasionally occur as with any communications system, the structure of the AHI APDU 1400, including the MCID 1408 and parity fields 1410, can enable recovery.

As shown in FIG. 15 and FIG. 16, the orchestration hub 104 can notify a device manager when an AHI APDU 1400 is ready for transport to the device. The orchestration hub 104 can construct the AHI APDU 1400 when the device manager 106 calls the request APDU operation 1504. By waiting for the request APDU operation 1504, the orchestration hub 104 can support one or more devices with long periods of unavailability. For example, one or more devices installed in a seasonal venue can be repeatedly powered off and stored for the better part of a year, long enough that business conditions can change before a campaign can be completed. While waiting for the device to become available, business conditions may change and the orchestration hub 104 can manage AHI APDUs 1400 by removing those that are no longer needed or by generating new AHI APDUs 1400 with newer updates or campaigns.

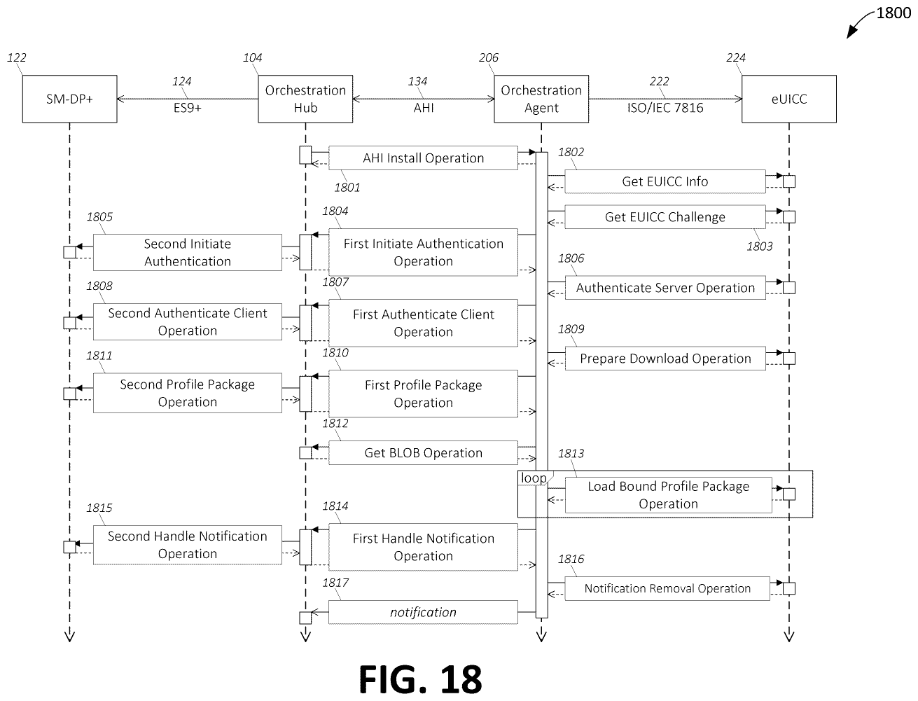

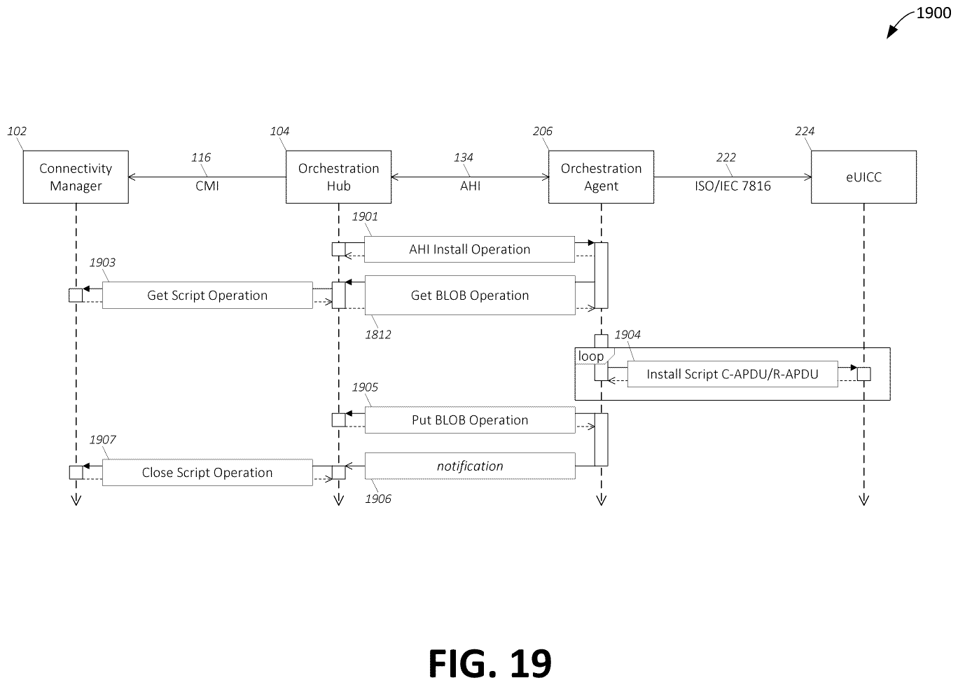

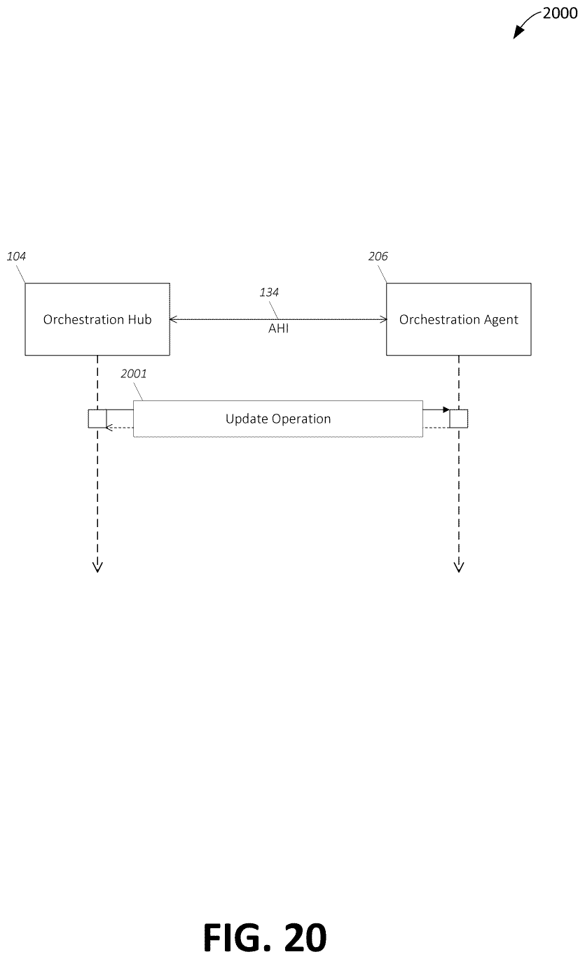

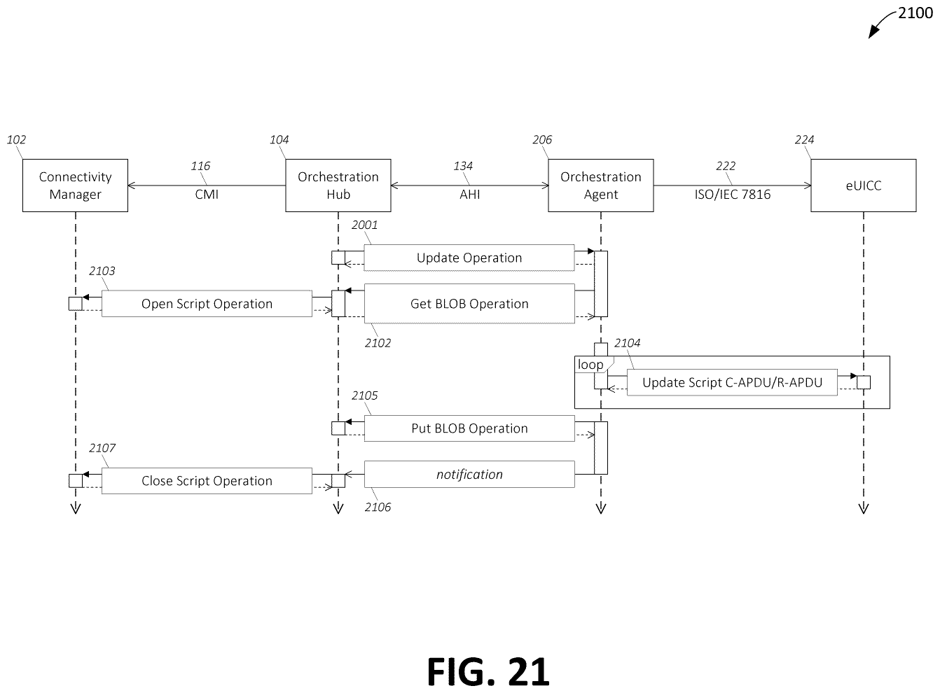

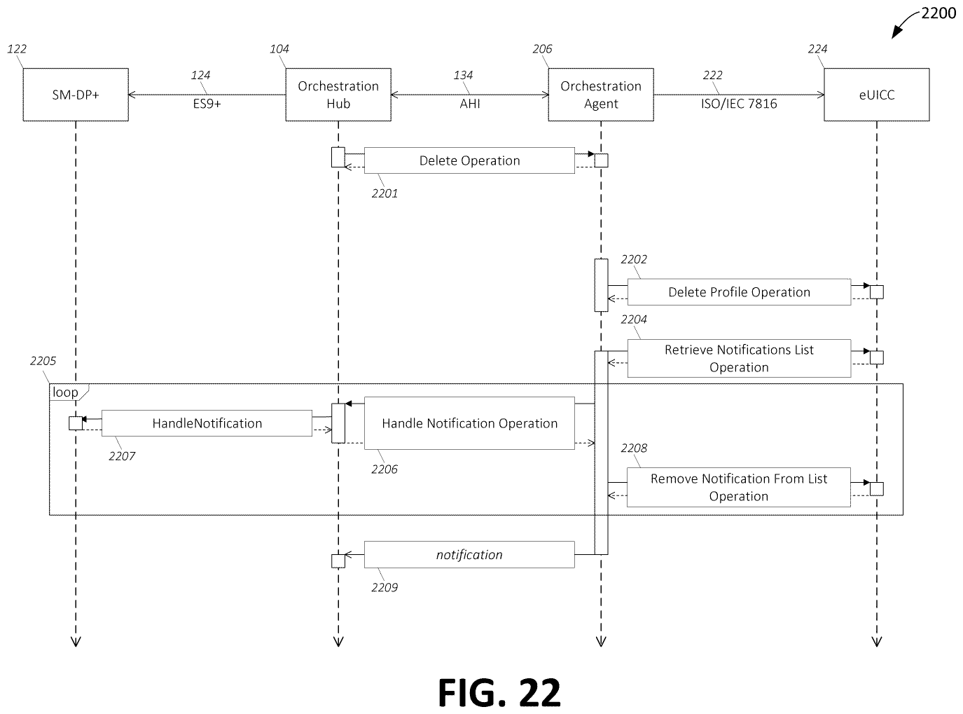

Referring now to FIGS. 18-22, illustrated are five distinct example operations performed by the disclosed innovation. The five distinct example operations are not intended to limit the scope of the disclosed innovation and other operations can be performed by the disclosed innovation than those currently appreciated. The five distinct operations can include but are not limited to a first install operation (see FIG. 18 for further details), a second install operation (see FIG. 19 for further details), a first update operation (see FIG. 20 for further details), a second update operation (see FIG. 21 for further details), and a delete operation (see FIG. 22 for further details). The disclosed innovation can further perform activation operations and suspension operations. For example, the first install operation and the second install operation can include installing the subscription edge record, with assistance from an SM-DP+ server or installation script. The first update operation and the second update operation can include updating the subscription edge record. The delete operation can include deleting the subscription edge record. The activation operation and the suspension operation can include activating and suspending the subscription edge records, respectively.

Referring now to FIG. 18, illustrated is a first install operation 1800, according to one example of the disclosed technology. The first install operation 1800 can include a sequence diagram showing an example progression of a particular installation operation, where the disclosed innovation can install a subscription edge record 402 into one or more devices. The orchestration hub 104 can interface with the SM-DP+ server 122 through the ES9+ interface 124. The orchestration hub 104 can interface with the orchestration agent 206 using the AHI 134. The orchestration agent 206 can connect to the eUICC 224. The eUICC 224 can be compatible with SGP.22 version 2.4 and/or any other particular remote sim provisioning architecture.

The orchestration hub 104 can invoke an AHI install operation 1801 to the orchestration agent 206. The AHI install operation 1801 can define a request to install a subscription edge record 402. For example, the AHI install operation 1801 include a technique for beginning an install operation. Continuing this example, the AHI install operation 1801 parameters can include but are not limited to an operation_id and the subscription context fields shown in Table 5. The band_list, plmn_rank, geo, cm_attributes, dm_attributes, cm_extdata, and dm_extdata fields of the subscription context fields shown in Table 5 can contain inline data or BLOB identifiers for subsequent retrieval in cases where the subscription context is larger than the maximum APDU size. During the initial installation phase, the orchestration agent 206 can save the subscription context into a new subscription edge record 402 in the local store 218. The orchestration agent 206 can return a successful completion of the AHI install operation 1801 call to the orchestration hub 104.

The orchestration agent 206 can request an EUICC and/or HUB lock as described in Table 1. When the EUICC and/or HUB lock are acquired (possibly after an arbitrary period of time), the orchestration agent 206 can open a logical channel with the ISD-R of the destination eUICC 224, perform a get EUICC Info operation 1802, and then can perform a get EUICC challenge operation 1803.

Using EUICC data from the get EUICC info operation 1802 and the EUICC challenge data from the get EUICC challenge operation 1803, the orchestration agent 206 can invoke an initiate authentication reverse operation 1804. The first initiate authentication operation 1804 can include a technique for proxying an ES9+ Initiate Authentication operation through the orchestration hub 104 to the SM-DP+ server 122 as part of the Common Mutual Authentication Procedure. In response to the first initiate authentication operation 1804, the orchestration hub 104 can acquire the SM-DP+ URL from the subscription hub row 404 and can perform a corresponding second initiate authentication operation 1805 with the appropriate SM-DP+ server 122. The second initiate authentication operation 1805 can trigger a response from the SM-DP+ server to generate transactionID, serverSigned1, serverSignature1, euiccCiPKIdToBeUsed, and serverCertificate fields, which the orchestration hub 104 can return to the orchestration agent 206 through the first initiate authentication operation 1804.

The orchestration agent 206 can construct a CtxParams1 value, as described in SGP.22 version 2.4, using a dpp_token field from the subscription context as well as information associated with the modem 208 (received from the device application 204). With the CtxParams1 value, as well as the transactionID, serverSigned1, serverSignature1, euiccCiPKIdToBeUsed, and serverCertificate fields, the orchestration agent 206 can perform an authenticate server operation 1806.

The orchestration agent 206 can invoke a first authenticate client operation 1807 using the transactionID value returned by the first initiate authentication operation 1804 and the authenticateServerResponse value returned by the authenticate server operation 1806. The orchestration hub 104 can subsequently perform a second authenticate client operation 1808 with the appropriate SM-DP+ server 122. The second authenticate client operation 1808 can include relaying the transactionID field and an authenticateServerResponse field between the SM-DP+ server 122 and the orchestration hub 104. The second authenticate client operation 1808 can include transactionID, profileMetadata, smdpSigned2, smdpSignature2, and smdpCertificate fields, which the orchestration hub 104 can relay to the orchestration agent 206 as the return value of the first authenticate client operation 1807. The first authenticate client operation 1807 and/or the second authentication client operation 1808 can include a technique for proxying an ES9+ Authenticate Client operation through the orchestration hub 104 to the SM-DP+ server 122 as part of a Common Mutual Authentication Procedure.

Upon completion of the first authenticate client operation 1807 and the second authenticate client operation 1808, the orchestration agent 206 can examine the profileMetadata field and follow the process described in SGP.22 version 2.4, 3.1.3, steps 7 and 8. If user consent is required according to the PPR values in the eSIM profile metadata and the eUICC Rules Authorization Table, then the ppr1_consent and ppr2_consent fields in the subscription context can provide consent for PPR1 and PPR2 present the profile metadata. If PPR1 is present in the profile metadata and ppr1_consent is FALSE in the subscription context, or if PPR2 is present in profile metadata and ppr2_consent is FALSE in subscription context, then consent can be denied. If necessary, the orchestration agent 206 can perform ES10b.GetRat and ES10b.GetProfilesInfo functions to complete the evaluation process. If a confirmation_code value is present in the context information, then the orchestration agent 206 can generate a hashcc value from the cc fields of the subscription context using SHA256 as explained in the SGP.22 Specification, 3.1.3, step 8.

The orchestration agent 206 can perform a prepare download operation 1809. The prepare download operation can include extracting from the eUICC 224 parameters such as smdpSigned2, smdpSignature2, smdpCertificate, and hashcc (if the cc field is present in the subscription context). The orchestration agent 206 can invoke a first profile package operation 1810. The first profile package operation 1810 can include the transactionID and a ES10b.PrepareDownload response as parameters. The first profile package operation 1810 can include a technique for proxying an ES9+ GetBoundProfilePackage operation through the orchestration hub 104 to the SM-DP+ server 122. The orchestration hub can perform a second profile package operation 1811 with the appropriate SM-DP+ server 122. The SM-DP+ server 122 can reply with an ES9+ GetBoundProfilePackage response. The orchestration hub 104 can store the boundProfilePackage into its database, such as in a table row related to the subscription being installed. In one example, the orchestration hub 104 can return the boundProfilePackage output field to the orchestration agent 206 as part of the first profile package return value. In another example, the orchestration hub 104 can return the BLOB ID of the boundProfilePackage to the orchestration agent as part of the first profile package return value for subsequent retrieval by the orchestration agent 206 using a get BLOB operation 1812. The get BLOB operation 1812 can include a technique for reading a BLOB from the orchestration hub 104. The orchestration agent 206 can read the BLOB in its entirety or in segments spanning multiple method calls. Parameters read include but are not limited to blob_id, identifying the BLOB, offset, identifying the data start offset and length, and identifying the maximum byte length of data to return. The return value can include a result code, and, upon success, the requested data from the BLOB.

The orchestration agent 206 can call a Get BLOB operation 1812, receiving the BLOB ID returned by the first profile package operation 1810 as a BLOB_id parameter. The Get BLOB operation 1812 can return a bound profile package data to the orchestration agent 206.

The orchestration agent 206 can follow the process described in SGP.22 version 2.4 5.7.6, segmenting the bound profile package and invoking a load bound profile package operation 1813 multiple times as necessary. Once the final segment of the profile package is successfully loaded, the load bound profile package operation 1813 can return a ProfileInstallationResult value. In one example, the load bound profile package operation 1813 can be a “loadBoundProfilePackage ( )” operation according to GSMA standards.

The orchestration agent 206 can invoke a first handle notification operation 1814, passing the ProfileInstallationResult from the load bound profile package operation 1813 as a parameter. The orchestration hub 104 can invoke a second handle notification operation 1815 with the appropriate SM-DP+ server 122. Upon successful completion of the second handle notification operation 1815 and the first handle notification operation 1814 return value, the orchestration agent 206 can perform a notification removal operation 1816 with the eUICC 224. The orchestration agent 206 can send a notification 1817 to the orchestration hub 104 indicating the completion of the operation. The subscription install process of the illustrative embodiment can send more than one notification 1817 after the profile is successfully installed.

In one example, the subscription install process of the first install operation 1800 can download the complete bound profile package in a single Get BLOB operation 1812. In another example, the orchestration agent 206 can download the bound profile package using multiple Get BLOB operations 1812, or the first profile package operation 1810 can include a complete bound profile package in its return call, depending on resources and capabilities.

Referring now to FIG. 19, illustrated is a second install operation 1900 using a profile installation script, according to one example of the disclosed technology. The second install operation 1900 can illustrate a sequence diagram for installing the subscription edge record 402 into a particular device. The orchestration hub 104 can interface with the connectivity manager 102 using the CMI 116. The orchestration hub 104 can interface with the orchestration agent 206 using the AHI 134. The orchestration agent 206 can connect to the eUICC 224.

The orchestration hub 104 can invoke the AHI install operation 1901 to the orchestration agent 206. The parameters of the AHI install operation 1901 can include the subscription context fields shown in Table 5, including ins_script. The orchestration agent 206 can save the subscription context into a new subscription edge record 402 in its local store 218, with an initial state of INSTALLING 902. The orchestration agent 206 can return a successful completion of the AHI install operation 1901 to the orchestration hub 104. The orchestration agent 206 can invoke the get BLOB operation 1812 to retrieve the installation script from the orchestration hub 104, using the blob ID included in the ins_script field of the AHI install operation 1901. The orchestration hub 104 can invoke a CMI get script operation 1903, using the ins_script field of the Subscription Hub Row to retrieve the installation script from the connectivity manager 102. The get script operation 1903 can return the script, which is in turn returned to the orchestration agent 206 in the get BLOB operation 1902 return value.

The orchestration agent 206 can acquire an EUICC lock 312 and then execute the C-APDU components of the installation script 1904, capturing the R-APDU responses of each command. When all C-APDUs have been sent to the eUICC 224 and the loop completes, the orchestration agent 206 can release the EUICC lock, acquire a HUB lock, and invoke a put BLOB operation 1905 to write R-APDU data to the orchestration hub 104, using ins_script (from the AHI install operation 1901)+1 as the blob_id, and the R-APDU data as the blob data. The orchestration agent 206 can send a notification 1906 to the orchestration hub 104 indicating the completion of the operation. The orchestration hub 104 can invoke a close script operation 1907 to report the results of the installation script to the connectivity manager 102.

Referring now to FIG. 20 illustrated is a first update operation 2000 without profile content management, according to one example of the disclosed technology. The first update operation 2000 can illustrate a sequence diagram, which can include changes to the subscription context 414 of the subscription edge record 402. the orchestration hub 104 can use the AHI 134 to call an update operation 2001 of the orchestration agent 206. Since the update operation 2001 parameters only specify changes to the subscription context, the update operation 2001 can complete and return a successful status, thereby completing the operation.

Referring now to FIG. 21, illustrated is a second update operation 2100 with profile content management, according to one example of the disclosed technology. The second update operation 2100 can illustrate a technique for updating a subscription edge record 402, including both its subscriber identity 412 and subscription context 414. The orchestration hub 104 can use the AHI 134 to call the update operation 1601 of the orchestration agent 206. Since the update method parameters include a blob ID for an update script, the orchestration agent 206 can preimage an updated subscription context and return a pending status. The orchestration agent 206 can acquire an HUB lock and can invoke a get BLOB operation 2102 to retrieve the update script. Upon receiving the get_blob method call, the orchestration hub 104 can use the CMI 116 to issue a corresponding open script operation 2103 to the connectivity manager 102. The return value of the open script operation 2103 is relayed to the Orchestration Agent as the return value of the get BLOB operation 2102.

The orchestration agent 206 can release the HUB lock and can acquire an EUICC lock 312. The orchestration agent 206 can loop through the update script C-APDU commands 2104 while recording the R-APDU responses. Upon completion of all script commands, the orchestration agent 206 can release the EUICC lock 312 and can acquire the HUB lock. The orchestration agent 206 can invoke a put BLOB operation 2105 to convey responses to the update script. The orchestration agent 206 can send a notification 2106 indicating that the operation is complete, and releases all locks. The orchestration hub 104 can close the script using a close script operation 2107.

In embodiments with limited MTU size and other resource limitations, the orchestration agent 206 can replace the single get BLOB operation 2102 with multiple get BLOB operation 2102, and it may replace the single put BLOB operation 2105 with multiple put BLOB operation 2105.

Referring now to FIG. 22, illustrated is a delete operation 2200, according to one example of the disclosed technology. The orchestration hub 104 can use the AHI 134 to invoke a delete operation 2201 of the orchestration agent 206. After a possible delay of arbitrary duration, the orchestration agent 206 can acquire eUICC and modem lock and perform a delete profile operation 2202. The eUICC 224 can release its locks.

Depending on local circumstances and the configuration of the eSIM profile, the delete profile operation 2202 can generate notifications. The orchestration agent 206, therefore, can obtain EUICC and Hub locks. The orchestration agent 206 can perform a retrieve notifications list operation 2204. The orchestration agent 206 can begin an iterative loop 2205 for each notification. During each loop iteration 2205, the orchestration agent 206 can invoke a first handle notification operation 2206. The orchestration hub 104 can perform a second handle notification operation 2207 with the appropriate SM-DP+ server 122 using the ES9+ interface 124. The orchestration agent 206 can perform a remove notification from list operation 2208 with the eUICC 224, thereby clearing the notification from the eUICC memory.

Once the iterative loop 2205 is complete, the orchestration agent 206 can generate a notification 2209 to the orchestration hub. The notification 2209 can include information notifying the orchestration hub 104 that the subscription edge record 402 has been deleted. The orchestration hub 104 can take appropriate further actions, such as but not limited to termination of the subscription and other steps as appropriate.

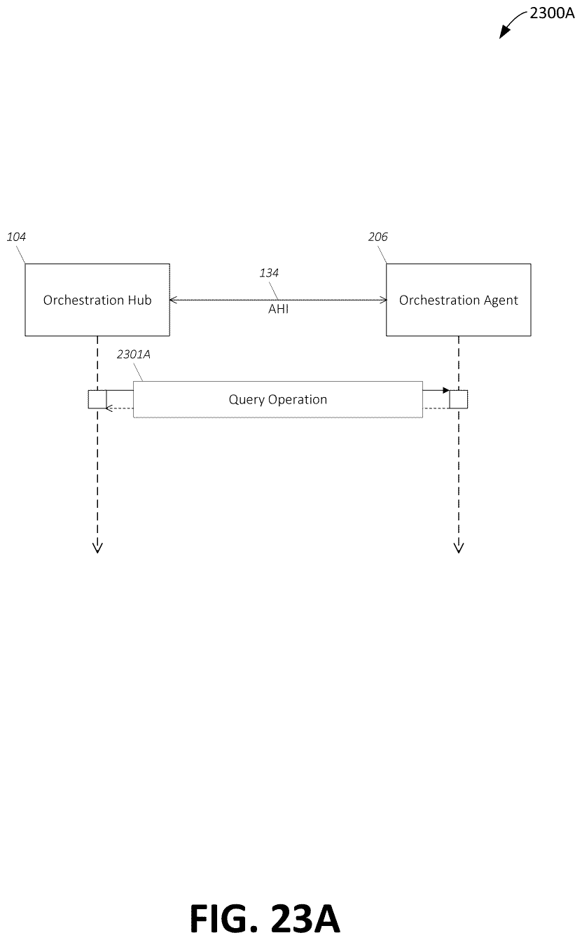

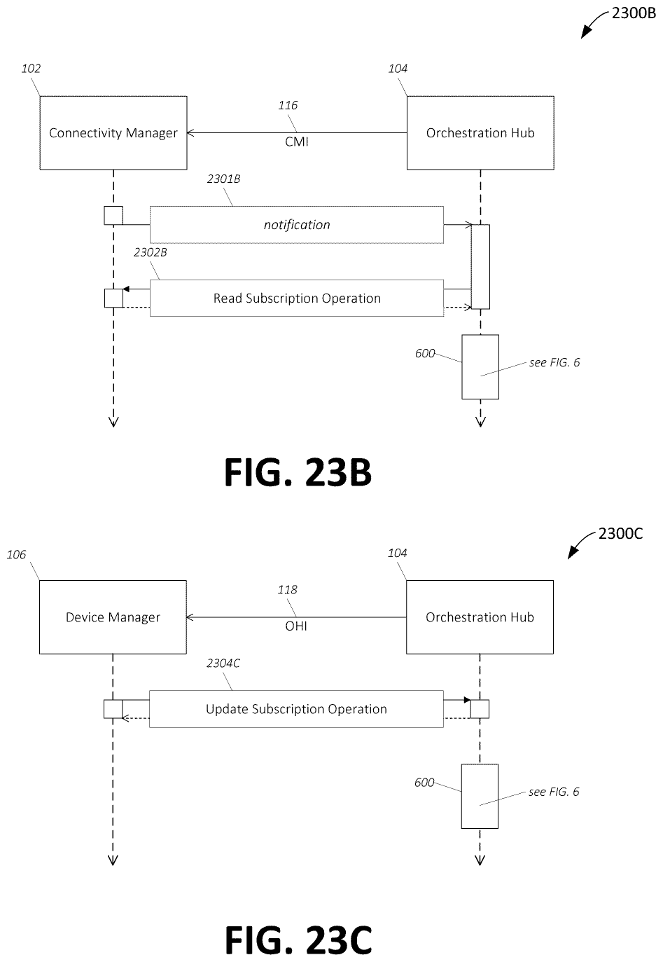

Referring now to FIG. 23A, illustrated is a general query operation 2300A, according to one example of the disclosed technology. The general query operation 2300A can include a technique for querying a particular device regarding the topology of its eUICCs 224, subscriptions, and modems. The orchestration hub 104 can use the AHI 134 to call the query method 2301A of an orchestration agent 206 to return the topology of the eUICCs 224, the subscriptions, and modems associated with the particular device.

Referring generally now to FIGS. 23B-C, device managers 106 and connectivity managers 102 can forward subscription source rows to the orchestration hub 104. By forwarding the subscription source rows to the orchestration hub 104, the orchestration hub 104 can replicate changes in the subscription hub rows to the subscription edge rows. The orchestration hub 104 can accomplish replicating changes in the subscription hub rows to the subscription edge rows with a two-stage system of asynchronous replication using the sub_uid, sub_rev fields of the Subscription Hub Row and subscription edge rows and the sync_state field of the subscription hub row.

Referring now to FIG. 23B, illustrated is a sequence diagram 2300B, according to one example of the disclosed technology. The sequence diagram 2300B can illustrate a progression of an asynchronous subscription update operation driven by a subscription source row update from a connectivity manager 102. the orchestration hub 104 can interface with the connectivity manager 102 using the CMI 116. After (for example) a rezoning operation that can change the PLMN list of a subscription, the connectivity manager 102 can generate a notification 2301B for the orchestration hub 104 stating the rezoning operation. The orchestration hub 104 can perform a read subscription operation 2302B to obtain the subscription source row. The orchestration hub 104 can follow the procedure 600 detailed in FIG. 6 to merge the update into the related subscription hub row.

Referring now to FIG. 23C, illustrated is a sequence diagram 2300C, according to one example of the disclosed technology. The sequence diagram 2300C can illustrate a progression of an asynchronous subscription update operation driven by the subscription source row update from the device manager 106. The orchestration hub 104 can interface with the device manager 106 using the OHA 111. After (for example) a user changes the rank of a particular subscription, the device manager 106 can update the subscription with updated fields in the subscription source row through an update subscription operation 2304C. The orchestration hub 104 can follow the procedure 600 detailed in FIG. 6 to merge the update into the related subscription hub row.

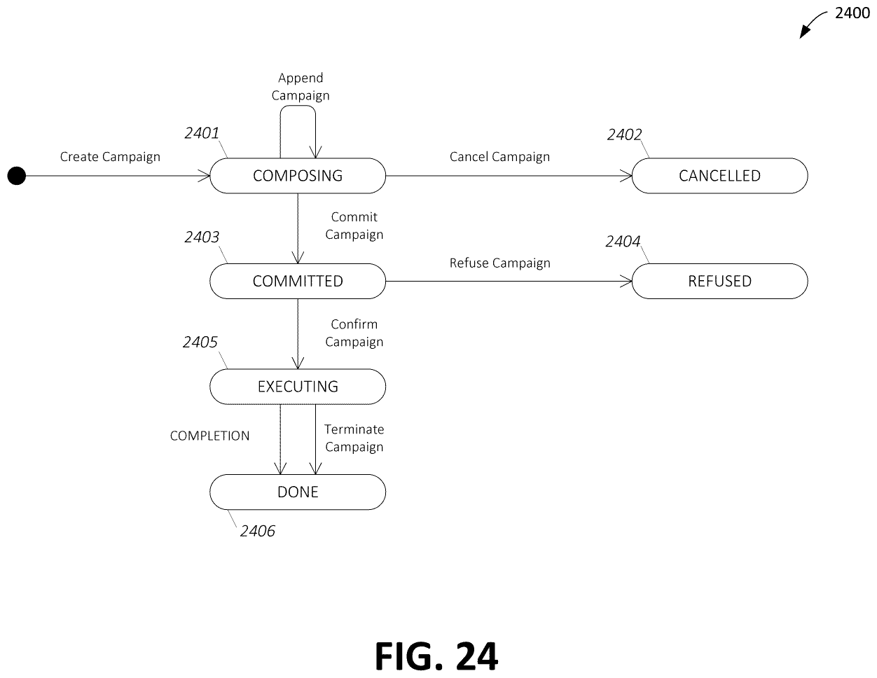

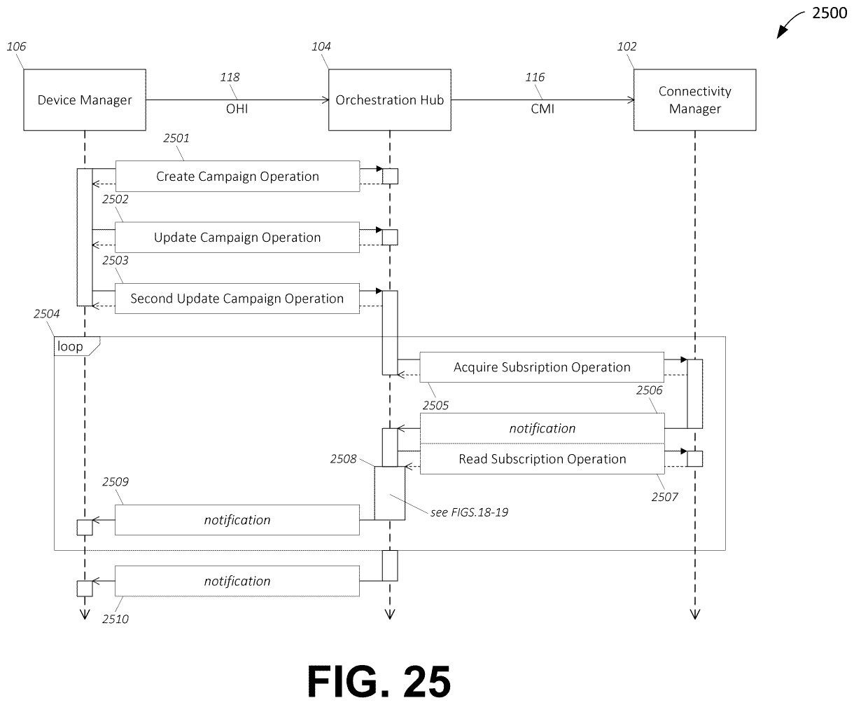

Referring generally to FIGS. 24-27, the disclosed innovation can enable a device manager 106 to organize operations into campaigns. Campaigns can be defined as sets of sequentially ordered operations applied to one or more devices. While operations can be sequential and ordered for each device in a campaign, devices themselves can be handled in parallel. For example, a campaign can include two installation operations, followed by a delete operation, each performed on 500 (or more) devices. The orchestration hub 104 can initiate all 500 install operations simultaneously, and as these operations complete, the orchestration hub 104 can begin the follow-on operations on a device-by-device basis. Campaigns can offer a useful management structure in cases where RSP operations may incur cost, which can be controlled and accounted for differently than other aspects of device management.

Referring now to FIG. 24, illustrated is a lifecycle state machine 2400 for a campaign, according to one example of the disclosed technology. The device manager 106 can create a campaign by invoking a create campaign operation of the OHI 118. The device manager 106 can create the campaign in a COMPOSING state 2401, at which time the device manager 106 can use subsequent append campaign operations to add additional operations and devices. The device manager 106 can invoke a cancel campaign operation to change the state to CANCELLED 2402. Alternatively or in addition, once the campaign is built, the device manager 106 can invoke a commit campaign operation to change the state to COMMITTED 2403. Once the campaign is in the COMMITTED state 2403, the device manager 106 can invoke a confirm campaign operation to change the state to EXECUTING 2405, or it can invoke a refuse campaign operation to change the state to REFUSED 2404. Once the campaign is in the EXECUTING state 2405, the device manager 106 can run the campaign to completion, unless terminated with a terminate campaign operation. Either condition can run the campaign into the terminal state DONE 2406.

The lifecycle state machine 2400 and the operations described above can permit controls and accounting to exist on both sides of OHI 118, which may be helpful in cases where an orchestration hub 104 may be provided as a service or where large campaigns are managed. For example, a device manager 106 may only permit confirm campaign operations to originate from certain user accounts, with those users following well-defined procedures to confirm or refuse campaigns. In cases where an orchestration hub 104 is more tightly integrated into a device management system, or where campaigns are smaller, these controls can be adjusted in favor of controls implemented primarily within the device manager 106. In these cases, a single device manager 106 and/or any other particular system of the disclosed technology can originate calls to create campaigns, commit campaigns, and confirm campaigns. The device manager 106 and/or any other particular system of the disclosed technology can prompt a dialog box prompt asking for confirmation before proceeding with the confirm campaign operation.

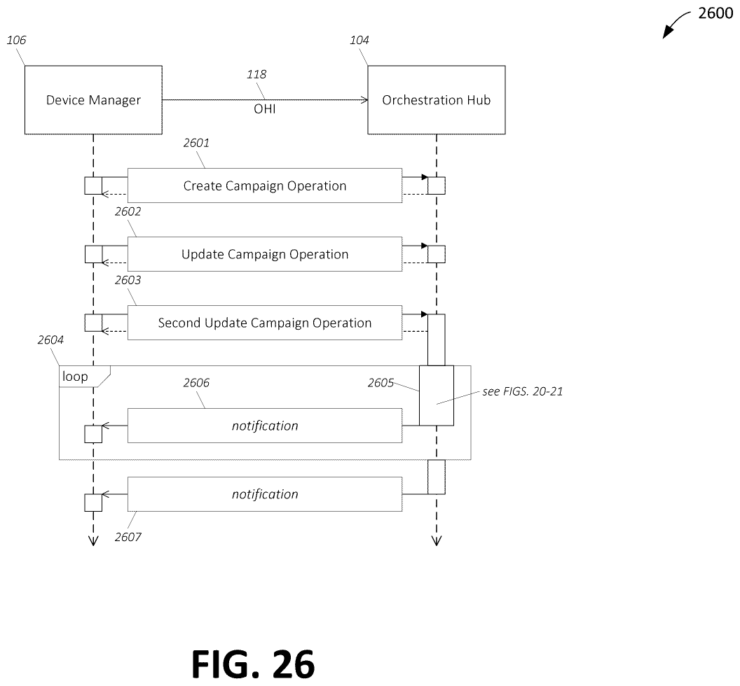

Referring now to FIG. 25, illustrated is a sequence diagram 2500 for a campaign of install operations, according to one example of the disclosed technology. The device manager 106 can invoke a create campaign operation 2501 to create a campaign. The create campaign operation 2501 parameters can include a list of device_id values, a modem_ordinal, a modem_slot, and a template_id. The device manager 106 can commit the campaign using an update command operation 2502, and subsequently approves the campaign using a second update command operation 2503. The orchestration hub 104 can begin a loop 2504 to iterate through the devices specified in the list of device_id values. The device manager 106 and/or the orchestration hub 104 can perform the loop 2504 sequentially, one device at a time, or in parallel for all devices, or as a sequence of parallel operations involving multiple devices, depending on available system resources and urgency. For each device, the orchestration hub 104 can acquire a subscription from the connectivity manager 102, using the CMI 116, by invoking an acquire subscription operation 2505. Once the subscription is acquired, the connectivity manager 102 can send a notification 2506 to the orchestration hub 104. The orchestration hub 104 can retrieve the subscription with a read subscription operation 2507. The disclosed innovation can subsequently execute the install operation 2508 as described in FIGS. 18-19 to install the desired information on each particular device. For example, for subscriptions installed using the SM-DP+ downloads, the example embodiment can employ the first installation operation 1800 of FIG. 18. In another example, for subscriptions installed using profile installation scripts, the illustrative embodiment can employ the second update operation 1900 of FIG. 19. In response to completing the install operation, the orchestration hub 104 can send a progression notification 2509 to the device manager 106. Once the loop 2504 is complete, the orchestration hub 104 can update the campaign state to DONE 2006 and send a final notification 2510 to the device manager 106 indicating the completion of the campaign.

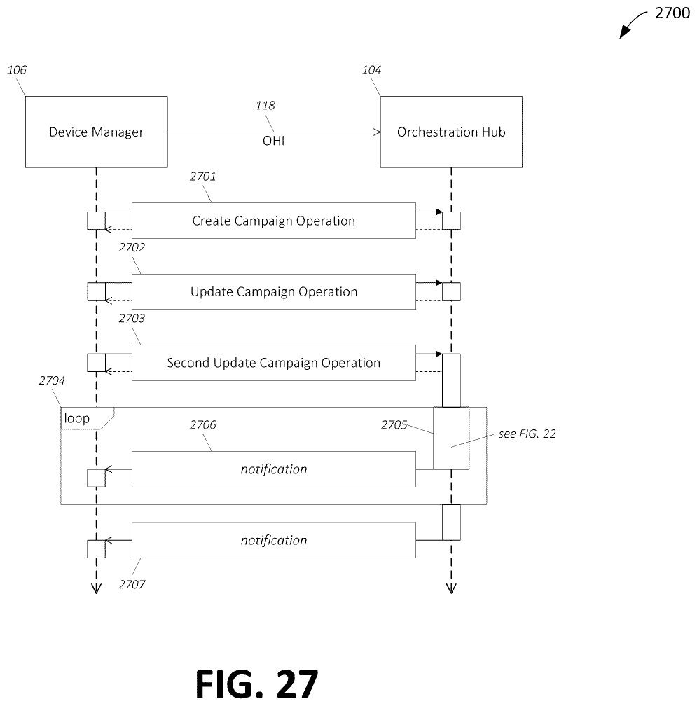

Referring now to FIG. 26, illustrated is a sequence diagram 2600 for a campaign of update operations, according to one example of the disclosed technology. The device manager 106 can invoke the create campaign operation 2601 to create a campaign. The parameters of the create campaign operation 2601 can include a list of subscription identifiers. The device manager 106 can commit the campaign using an update campaign operation 2602. The device manager 106 can subsequently approve the campaign using a second update campaign operation 2603. The orchestration hub 104 can organize the subscription identifiers into common devices and begin a loop 2604 to iterate through the devices. The device manager 106 and/or orchestration hub 104 can perform the loop 2604 sequentially, one device at a time, or in parallel for all devices, or as a sequence of parallel operations involving multiple devices, depending on available system resources and urgency. The device manager 106 and/or any other system of the disclosed technology can execute the update operation 2605 as illustrated in FIGS. 20-21 for each particular device. For example, for subscriptions updated without profile content management, the illustrative embodiment can employ the first update operation 2000 of FIG. 20. In another example, for subscriptions updated with profile content management, the illustrative embodiment can employ the second operation 2100 of FIG. 21. The orchestration hub 104 can generate the notification 2606 as each device is updated. The orchestration hub 104 can generate the notification 2607 indicating the campaign has been completed.

Referring now to FIG. 27, illustrated is a sequence diagram 2700 for a campaign of delete operations, according to one example of the disclosed technology. The device manager 106 can invoke the create campaign operation 2701 to create a campaign. The parameters of the create campaign operation 2701 can include a list of subscription identifiers. The device manager 106 can commit the campaign using an update campaign operation 2702. The device manager 106 can subsequently approve the campaign using a second update campaign operation 2703. The orchestration hub 104 can organize the subscription identifiers into common devices and begin a loop 2704 to iterate through the devices. The device manager 106 and/or orchestration hub 104 can perform the loop 2704 sequentially, one device at a time, or in parallel for all devices, or as a sequence of parallel operations involving multiple devices, depending on available system resources and urgency. The device manager 106 and/or any other system of the disclosed technology can execute one or more delete operations (such as the operation 2201 as illustrated in FIG. 22) for each particular device. In one example, an “UpdateCampaign ( )” operation can be used for updating campaign information, or deleting a campaign or campaign information. The orchestration hub 104 can generate the notification 2706 as each device has its particular data deleted. The orchestration hub 104 can generate the notification 2707 indicating the campaign has been completed.

In one example, the operations referred to herein (and particularly with respect to the sequence diagrams illustrated and discussed in connection with FIGS. 15-27) can be GSMA operations, or operations according to other standards, specifications, and protocols. For example, the operations can correspond to operations described in the SGP.02, SGP.22, and SGP.32 standards (and other standards). In at least one example, the “Request APDU Operation” step 1504 of FIG. 15 can correspond to the GSMA “GetApdu ( )” operation. In another example, operations such as “Get EUICC Info” as discussed in connection with step 1802 of FIG. 18, can correspond to operations described in accordance with the ES10 interface, such as “ES10b.GetEUICCInfo.” In other examples, operations such as “First Initiate Authentication Operation” 1804 of FIG. 18, can correspond to operations described in accordance with ES9+ interface, such as “es9p_InitiateAuthentication ( )” Further, operations such as “Second Initiate Authentication” at step 1805 of FIG. 18, can correspond to the GSMA “InitiateAuthentication” operation. Accordingly, despite certain operations being referred to in a generalized form (for ease of understanding), it should be understood from the discussion herein that those operations correspond to the one or more standards, specifications, and protocols as described throughout the present disclosure.

### CONCLUSION

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, or in the case of an NFC wrist band or RFID device, by holding it in close proximity or tapping it to an NFC or RFID enabled computer, smartphone or mobile device, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A system comprising:
an orchestration agent comprising a software configuration installed at a mobile computing device, wherein the orchestration agent is operatively connected to an embedded universal integrated circuit card (eUICC) and memory at the mobile computing device; and
an orchestration hub operatively connected to the orchestration agent, wherein the orchestration hub comprises a processor and a database including centralized network subscription information sourced from one or more management platforms, wherein the processor is operatively configured to:
receive first updated network subscription information from a device management platform of the one or more management platforms;
receive second updated network subscription information from a network connectivity management platform of the one or more management platforms;
compare the first updated network subscription information and the second updated network subscription information to a plurality of subscription records in the centralized network subscription information;
in response to determining a common identifier between a particular subscription record of the plurality of subscription records, the first updated network subscription information, and the second updated network subscription information, generate a new subscription record including current network subscription information based on the first updated network subscription information and the second updated network subscription information; and
transmit a replicated version of the new subscription record to the orchestration agent at the mobile computing device, wherein the orchestration agent is operatively configured to replace one or more information fields of a subscription edge record at the eUICC and the memory with corresponding information fields from the replicated version of the new subscription record.

2. The system of claim 1, wherein the common identifier is an Integrated Circuit Card Identification (ICCID) value.

3. The system of claim 1, wherein transmitting the replicated version of the new subscription record to the orchestration agent comprises transmitting the replicated version of the new subscription record to the orchestration agent through a network tunnel.

4. The system of claim 1, wherein the orchestration hub is operatively configured to transmit the replicated version of the new subscription record in response to receiving an indication of device availability.

5. The system of claim 1, wherein the orchestration hub is operatively connected to a subscription manager data preparation plus (SM-DP+) server.

6. The system of claim 5, wherein the subscription edge record comprises an eSIM profile received from the SM-DP+ server and stored within the eUICC, and the subscription edge record further comprises subscription context information received from the network connectivity management platform and stored within the memory.

7. The system of claim 6, wherein the orchestration hub is operatively configured to update the eSIM profile via one or more APDU scripts.

8. A method comprising:
receiving first updated network subscription information from a device management platform of one or more management platforms;
receiving second updated network subscription information from a network connectivity management platform of the one or more management platforms;
comparing the first updated network subscription information and the second updated network subscription information to a plurality of subscription records in centralized network subscription information stored in an orchestration hub;
in response to determining a common identifier between a particular subscription record of the plurality of subscription records, the first updated network subscription information, and the second updated network subscription information, generating a new subscription record including current network subscription information based on the first updated network subscription information and the second updated network subscription information; and
transmitting a replicated version of the new subscription record to an orchestration agent at a mobile computing device, wherein the orchestration agent is operatively configured to replace one or more information fields of a subscription edge record at an eUICC and a memory at the mobile computing device with corresponding information fields from the replicated version of the new subscription record.

9. The method of claim 8, wherein the common identifier is an Integrated Circuit Card Identification (ICCID) value.

10. The method of claim 8, wherein transmitting the replicated version of the new subscription record to the orchestration agent comprises transmitting the replicated version of the new subscription record to the orchestration agent through a network tunnel.

11. The method of claim 8, wherein the orchestration hub is operatively configured to transmit the replicated version of the new subscription record in response to receiving an indication of device availability.

12. The method of claim 8, wherein the orchestration hub is operatively connected to a subscription manager data preparation plus (SM-DP+) server.

13. The method of claim 8, wherein the subscription edge record comprises an eSIM profile received from the SM-DP+ server and stored within the eUICC, and the subscription edge record further comprises subscription context information received from the network connectivity management platform and stored within the memory.

14. The method of claim 13, wherein the orchestration hub is operatively configured to update the eSIM profile via one or more APDU scripts.

15. A non-transitory computer readable medium comprising instructions, that when read by a processor, cause the processor to perform:
receiving first updated network subscription information from a device management platform of one or more management platforms;
receiving second updated network subscription information from a network connectivity management platform of the one or more management platforms;
comparing the first updated network subscription information and the second updated network subscription information to a plurality of subscription records in centralized network subscription information stored in an orchestration hub;
in response to determining a common identifier between a particular subscription record of the plurality of subscription records, the first updated network subscription information, and the second updated network subscription information, generating a new subscription record including current network subscription information based on the first updated network subscription information and the second updated network subscription information; and
transmitting a replicated version of the new subscription record to an orchestration agent at a mobile computing device, wherein the orchestration agent is operatively configured to replace one or more information fields of a subscription edge record at an eUICC and a memory at the mobile computing device with corresponding information fields from the replicated version of the new subscription record.

16. The non-transitory computer readable medium of claim 15, wherein the common identifier is an Integrated Circuit Card Identification (ICCID) value.

17. The non-transitory computer readable medium of claim 15, wherein transmitting the replicated version of the new subscription record to the orchestration agent comprises transmitting the replicated version of the new subscription record to the orchestration agent through a network tunnel.

18. The non-transitory computer readable medium of claim 15 further comprising instructions that, when read by the processor, cause the orchestration hub to transmit the replicated version of the new subscription record in response to receiving an indication of device availability.

19. The non-transitory computer readable medium of claim 15, wherein the orchestration hub is operatively connected to a subscription manager data preparation plus (SM-DP+) server.

20. The non-transitory computer readable medium of claim 19, wherein the subscription edge record comprises an eSIM profile received from the SM-DP+ server and stored within the eUICC, and the subscription edge record further comprises subscription context information received from the network connectivity management platform and stored within the memory, and wherein the wherein the orchestration hub is operatively configured to update the eSIM profile via one or more APDU scripts.
